(19) United States
(12) Patent Application Publication
(10) Pub. No.: US 2024/0382944 A1
(43) Pub. Date: Nov. 21, 2024

(54) WALL FLOW HONEYCOMB FILTERS AND METHOD OF MANUFACTURE

(71) Applicant: Corning Incorporated, CORNING, NY (US)

(72) Inventor: Lutz Franz Thomas Kercher, CORNING, NY (US)

(21) Appl. No.: 18/702,619

(22) PCT Filed: Nov. 14, 2022
(86) PCT No.: PCT/US2022/049819

§ 371 Date: Apr. 18, 2024

Related U.S. Application Data
(60) Provisional application No. 63/282,836, filed on Nov. 24, 2021.

(51) Int. Cl. B01J 37/02; B01J 23/63; C04B 38/00; C04B 41/45; C04B 111/00

(52) U.S. Cl. CPC B01J 37/0215; B01J 23/63; C04B 38/0009; C04B 41/4572; C04B 2111/00793

(57) ABSTRACT

Method of making and filtration article comprising a plugged honeycomb filter body comprising: intersecting porous walls extending an axial length in an axial direction from a proximal end to a distal end of the honeycomb filter body and defining a plurality of axial channels comprised of inlet channels, which are plugged at the distal end of the plugged honeycomb filter body, and outlet channels, which are plugged at the proximal end of the plugged honeycomb filter body, the porous walls comprising: porous ceramic base portions with a plurality of pores and an average thickness and having inlet sides and outlet sides; inlet surfaces defining the inlet channels; outlet surfaces defining the outlet channels; and treated sides comprising hydrophobic material deposits disposed at one of the inlet sides or the outlet sides of the porous ceramic base portions.

### CROSS REFERENCE TO RELATED APPLICATION

This application claims the benefit of priority under 35 U.S.C. § 119 of U.S. Provisional Application Ser. No. 63/282,836 filed on Nov. 24, 2021, the content of which is relied upon and incorporated herein by reference in its entirety.

### BACKGROUND

### Field

The present specification relates to articles for emissions treatment, and methods of making and using such articles which comprise porous walls, for example, of plugged honeycomb filter bodies, which include porous ceramic base portions comprising treated sides comprising hydrophobic material deposits, disposed at one of the inlet or outlet sides and non-treated sides comprising a catalytic material disposed at opposite sides of the porous ceramic base portions.

### Technical Background

Wall flow filters are employed to remove particulates from fluid exhaust streams, such as from combustion engine exhaust. Examples include ceramic soot filters used to remove particulates from diesel engine exhaust gases; and gasoline particulate filters (GPF) used to remove particulates from gasoline engine exhaust gases. For wall flow filters, exhaust gas to be filtered enters inlet cells and passes through the cell walls to exit the filter via outlet channels, with the particulates being trapped on or within the inlet cell walls as the gas traverses and then exits the filter.

GPFs can be used in conjunction with gasoline direct injection (GDI) engines, which emit more particulates than conventional gasoline engines.

Three-way conversion (TWC) catalysts are used to convert combustion by-products such as carbon monoxides, nitrogen oxides, and hydrocarbons emitted from gasoline engines.

### SUMMARY

Aspects of the disclosure pertain to porous bodies and methods for their manufacture and use.

An aspect is a filtration article comprising: a plugged honeycomb filter body comprising intersecting porous walls. The intersecting porous walls extend an axial length in an axial direction from a proximal end to a distal end of the honeycomb filter body and defining a plurality of axial channels comprised of inlet channels, which are plugged at the distal end of the plugged honeycomb filter body, and outlet channels, which are plugged at the proximal end of the plugged honeycomb filter body. The porous walls comprise: porous ceramic base portions with a plurality of pores and an average thickness and having inlet sides and outlet sides; inlet surfaces defining the inlet channels; outlet surfaces defining the outlet channels; and treated sides comprising hydrophobic material deposits disposed at one of the inlet sides or the outlet sides of the porous ceramic base portions.

Another aspect is a method for making a filtration article, the method comprising: applying a hydrophobic material to treated sides of porous ceramic base portions of a plugged honeycomb filter body, thereafter applying a catalytic material to non-treated sides of the porous ceramic base portions which are opposite the treated sides, and thereafter removing at least a portion of the hydrophobic material from the honeycomb filter body. The honeycomb filter body comprises intersecting porous walls extending an axial length in an axial direction from a proximal end to a distal end of the honeycomb filter body and defining a plurality of axial channels comprised of inlet channels, which are plugged at the distal end of the plugged honeycomb filter body, and outlet channels, which are plugged at the proximal end of the honeycomb filter body, the porous walls comprise: the porous ceramic base portions with a plurality of pores and an average thickness and having inlet sides and outlet sides, inlet surfaces defining the inlet channels; and outlet surfaces defining the outlet channels.

Additional features and advantages will be set forth in the detailed description, which follows, and in part will be readily apparent to those skilled in the art from that description or recognized by practicing the embodiments described herein, comprising the detailed description, which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a honeycomb body according to embodiments disclosed and described herein;

FIG. 2 schematically depicts a particulate filter according to embodiments disclosed and described herein;

FIG. 3 is a cross-sectional longitudinal view of the particulate filter shown in FIG. 2;

FIG. 4 is a flowchart depicting an exemplary embodiment of a process of preparing an emissions treatment article according to embodiments disclosed herein;

FIG. 5 is a flowchart depicting an exemplary embodiment of a process of forming deposits of inorganic material on a substrate according to embodiments disclosed herein;

FIG. 6 schematically depicts a cross-sectional view of a section of a porous wall of a honeycomb body including a catalytic material loaded in the pores (prior art);

FIG. 7 schematically depicts a cross-sectional view of a section of a porous wall of a honeycomb body including hydrophobic material deposits and a catalytic material loaded in the pores deposited thereafter in accordance with one or more embodiments herein;

FIG. 8 schematically depicts the cross-sectional view of the porous wall of FIG. 7 and after removal of the hydrophobic material deposits in accordance with one or more embodiments herein;

FIG. 9 schematically depicts the cross-sectional view of the porous wall of FIG. 7 and after removal of the hydrophobic material deposits further including inorganic deposits deposited onto the walls in accordance with one or more embodiments herein;

FIG. 10 is an axial cross-sectional schematic view of a section of a porous wall of an article according to embodiments disclosed herein;

FIG. 11 is an axial cross-sectional schematic view of a section of a porous wall of an article according to embodiments disclosed herein;

FIG. 12 is an axial cross-sectional schematic view of a section of a porous wall of an article according to embodiments disclosed herein; and

FIG. 13 is an axial cross-sectional schematic view of a section of a porous wall of an article according to embodiments disclosed herein.

### DETAILED DESCRIPTION

Reference will now be made in detail to embodiments of articles for emissions treatment, for example, filtration articles, comprising a plugged honeycomb filter body whose intersecting porous walls comprise: porous ceramic base portions with a plurality of pores and an average thickness and having inlet sides and outlet sides; inlet surfaces defining the inlet channels; outlet surfaces defining the outlet channels; and treated sides comprising hydrophobic material deposits disposed at one of the inlet sides or the outlet sides of the porous ceramic base portions. The intersecting porous walls extend an axial length in an axial direction from a proximal end to a distal end of the honeycomb filter body and defining a plurality of axial channels comprised of inlet channels, which are plugged at the distal end of the plugged honeycomb filter body, and outlet channels, which are plugged at the proximal end of the plugged honeycomb filter body. Whenever possible, the same reference numerals will be used throughout the drawings to refer to the same or like parts.

Aspects herein relate to articles, emissions treatment articles, in particular filtration articles, which are effective for filtration of particulates from gaseous streams and/or for catalytically converting combustion by-products such as carbon monoxides, nitrogen oxides, and hydrocarbons. Aspects also relate to manufacture of such articles and their use.

Ceramic honeycomb wall-flow particulate filters disclosed herein are coated and/or catalyzed for emissions treatment such as mobile emissions treatment. For coating and/or catalytic processes, it is desirable that the underlying particulate filters do not introduce variability in such processes to deliver a coated/catalyzed product with uniform and controllable coating depositions, which in turn facilitates a predictable pressure drop of the filter body during use. Advantageously, the articles and processes herein provide such attributes. Reducing coated pressure drop variability is achieved through surface treatment of a particulate filter prior to catalyzation by applying a hydrophobic material at the sides and/or in the channels and/or on the surfaces that are not to be washcoated. Such hydrophobic material subsequently fully or partially burns off from the honeycomb body preferably during a washcoat calcining process leaving behind bare ceramic surfaces or ceramic surfaces with materials that add benefits (e.g., reduced soot loaded dP).

Advantageously, high permeability of uncoated sections of the filter body is maintained. In addition, increased uniformity of coating process at coater/catalyzer is preferably realized. Also, control of coatability during downstream processing is also achieved.

Surfaces of a bare, uncatalyzed filter are surface treated with a material that is hydrophobic and such material burns off fully or partially preferably during a subsequent process of calcining later-applied catalytic material. In one or more embodiments, the hydrophobic material is purely organic (e.g., wax). In one or more embodiments, the hydrophobic material is a mix of organic and inorganic components. An example of such inorganic components is hydrophobic silica. The hydrophobic surface treatment preferably comprises applying the hydrophobic material from an end of the filter body opposite from the end of the filter body which will accept catalytic washcoat (“washcoating direction”).

Surface treatment material can be applied by an aerosol-based process with or without a thermal process (e.g., thermal spray) to treat the surfaces of walls defining an inlet channel of the filter. Alternately, the surface treatment for inlet channel walls could be by a vacuum infiltration and liquid coating process. Materials could be used which are wax-based or other organic materials that can be completely removed at a temperature of greater than or equal to 400° C., including a calcining temperature range of greater than or equal to 500° C. to less than or equal to 600° C., and all values and subranges therebetween. Higher temperature hydrophobic organics and/or hydrophobic inorganic materials could be included that leave behind a prepared or treated surface which can be advantageously adjusted to achieve a favorable performance, e.g., soot loaded dP.

An inlet surface treatment inhibits and/or prevents the washcoating material from entering the treated region, which catalytic washcoat material in one or more embodiments may be applied from an outlet side, from penetrating through the surface of the filter onto the inlet side of the porous walls of the honeycomb matrix. Catalytic coating can be applied by vacuum, or by waterfall process, to coat the filter from the untreated (non-hydrophobic) side, preferably such that no coating is present on the treated surface of the filter—during and after application of the catalyst material—thereby inhibiting and/or preventing a reduction in permeability and preserving the high porous surface structure of the filter. In another aspect, for a washcoating on the inlet side, the surface treatment can be applied to the outlet side.

The catalyst material applied for example by washcoating is then calcined. After the calcination process, the hydrophobic layer deposited on the inlet channel surfaces may be in one aspect completely burned off leaving the bare ceramic surface, or in another aspect burned off leaving char/soot that could serve to treat the surfaces of the inlet channels, for instance to control pressure drop (dP) through the filter body during soot deposition during engine operation Organics may be burned off with inorganics remaining as a particulate deposits to treat the surface of the inlet channels for soot-loaded dP.

The “hydrophobic material” of hydrophobic material deposits preferably comprise an organic material, or a mixture of organic and inorganic materials. Reference to a mixture of organic and inorganic materials includes both a single hybrid compound having both features, or a blend of individual compounds having one or more of the features. In one or more embodiments, the hydrophobic material comprises one or more hydrophobic components. In one or more embodiments, the hydrophobic material comprises: a material selected from the group consisting of: soot, starch, and polymer powders. In one or more embodiments, the hydrophobic material comprises a hydrophobic inorganic component. In one or more embodiments, the hydrophobic material comprises hydrophobic silica. In one or more embodiments, the mixture of organic and inorganic materials comprises hydrophobic silica. In one or more embodiments, the hydrophobic material is an organic material, which preferably is a wax-based compound. In one or more embodiments, the hydrophobic material comprises one or more hydrophobic inorganic components. In one or more embodiments, the hydrophobic material comprises one or more hydrophobic components and one or more non-hydrophobic components. In one or more embodiments, the hydrophobic material comprises one or more hydrophobic components and no non-hydrophobic components.

In embodiments, the honeycomb filter bodies of the filtration articles herein further comprise inorganic deposits. In one or more embodiments, the inorganic deposits are at an inlet side of the article. The “inorganic deposits” of the honeycomb filter body are preferably non-engine inorganic deposits. That is, the inorganic deposits of the honeycomb filter body are not reliant on deposits of soot or metals or the like coming from the engine exhaust itself. For example, the inorganic deposits of the honeycomb filter body are applied to the article itself at manufacture and prior to connection to an engine exhaust system. In one or more embodiments, the inorganic deposits of the honeycomb body are free from rare earth oxides such as ceria, lanthana, and yttria. In one or more embodiments, the inorganic deposits are free from catalyst, for example, an oxidation catalyst such as a platinum group metal (e.g., platinum, palladium and rhodium) or a selective catalytic reduction catalyst such as a copper, a nickel or an iron promoted molecular sieve (e.g., a zeolite). In one or more embodiments, the inorganic deposits are comprised of particles, aggregates, or agglomerates of one or more refractory materials, metals, ceramics, oxides, nitrides, glasses, or combinations thereof. Inorganic deposits can comprise: inorganic material, inorganic particulate material, and/or inorganic particles.

In embodiments, a loading of the catalytic material is between 0.5 g/in³ (30 g/L) to 2.5 g/in³ (150 g/L) within the honeycomb body, and all values and subranges therebetween. Within the honeycomb body refers to locations on walls and/or in pores of the walls. In specific embodiments, the loading of the catalytic material is in a range of from 35 to 145 g/L, 40 to 140 g/L, 50 to 130 g/L, 60 to 125 g/L, 70 to 120 g/L, 80 to 110 g/L, 90 to 100 g/L within the honeycomb body. Loading of the catalytic material is weight of added material in grams divided by the geometric part volume in liters. The geometric part volume is based on outer dimensions of the honeycomb filter body (or plugged honeycomb body).

In some embodiments, the inorganic deposits comprise one or more inorganic materials, such as one or more ceramic or refractory materials. In some embodiments, the inorganic deposits is disposed on the walls to provide enhanced filtration efficiency, both locally through and at the wall and globally through the honeycomb body, at least in the initial use of the honeycomb body as a filter following a clean state, or regenerated state, of the honeycomb body, for example such as before accumulation of ash and/or soot occurs inside the honeycomb body after use of the honeycomb body as a filter.

In some embodiments, the inorganic deposits form a filtration material.

In one aspect, the filtration material is present as a layer disposed on the surface of one or more of the base portion of the walls of the honeycomb structure. The layer is preferably porous to allow the gas flow through the wall. In some embodiments, the layer is present as a continuous coating over at least part of the, or over the entire, surface of the one or more walls. In some embodiments of this aspect, the filtration material is flame-deposited filtration material.

In another aspect, the filtration material is present as a plurality of discrete regions of filtration material disposed on the surface of one or more of the base portions of the walls of the honeycomb structure. The filtration material may partially block a portion of some of the pores of the porous walls, while still allowing gas flow through the wall. In some embodiments of this aspect, the filtration material is aerosol-deposited filtration material. In some preferred embodiments, the filtration material comprises a plurality of inorganic particle agglomerates, wherein the agglomerates are comprised of particles, preferably nanoparticles, of inorganic or ceramic or refractory material. The agglomerates are preferably porous, thereby allowing gas to flow through the agglomerates, and in a preferred aspect are spherical agglomerates. The filtration material may further be comprised of aggregates of such agglomerates.

In some embodiments, a honeycomb body comprises a porous ceramic honeycomb body comprising a first end (or inlet end), a second end (or outlet end), and a plurality of walls having wall surfaces defining a plurality of inner channels. A deposited material such as a filtration material, such as inorganic deposits, which may be a porous inorganic layer, is disposed on one or more of the wall surfaces of the base portion of the walls of the honeycomb body. The inorganic deposits, which may be a continuous porous inorganic layer has a porosity in a range of from about 20% to about 95%, or from about 25% to about 95%, or from about 30% to about 95%, or from about 40% to about 95%, or from about 45% to about 95%, or from about 50% to about 95%, or from about 55% to about 95%, or from about 60% to about 95%, or from about 65% to about 95%, or from about 70% to about 95%, or from about 75% to about 95%, or from about 80% to about 95%, or from about 85% to about 95%, from about 30% to about 95%, or from about 40% to about 95%, or from about 45% to about 95%, or from about 50% to about 95%, or from about 55% to about 95%, or from about 60% to about 95%, or from about 65% to about 95%, or from about 70% to about 95%, or from about 75% to about 95%, or from about 80% to about 95%, or from about 85% to about 95%, or from about 20% to about 90%, or from about 25% to about 90%, or from about 30% to about 90%, or from about 40% to about 90%, or from about 45% to about 90%, or from about 50% to about 90%, or from about 55% to about 90%, or from about 60% to about 90%, or from about 65% to about 90%, or from about 70% to about 90%, or from about 75% to about 90%, or from about 80% to about 90%, or from about 85% to about 90%, or from about 20% to about 85%, or from about 25% to about 85%, or from about 30% to about 85%, or from about 40% to about 85%, or from about 45% to about 85%, or from about 50% to about 85%, or from about 55% to about 85%, or from about 60% to about 85%, or from about 65% to about 85%, or from about 70% to about 85%, or from about 75% to about 85%, or from about 80% to about 85%, or from about 20% to about 80%, or from about 25% to about 80%, or from about 30% to about 80%, or from about 40% to about 80%, or from about 45% to about 80%, or from about 50% to about 80%, or from about 55% to about 80%, or from about 60% to about 80%, or from about 65% to about 80%, or from about 70% to about 80%, or from about 75% to about 80%, and a continuous layer of the inorganic deposits has an average thickness of greater than or equal to 0.5 μm and less than or equal to 50 μm, or greater than or equal to 0.5 μm and less than or equal to 45 μm, greater than or equal to 0.5 μm and less than or equal to 40 μm, or greater than or equal to 0.5 μm and less than or equal to 35 μm, or greater than or equal to 0.5 μm and less than or equal to 30 μm, greater than or equal to 0.5 μm and less than or equal to 25 μm, or greater than or equal to 0.5 μm and less than or equal to 20 μm, or greater than or equal to 0.5 μm and less than or equal to 15 μm, greater than or equal to 0.5 μm and less than or equal to 10 μm. Average thickness may be determined by an overall average thickness (all walls in the honeycomb body) along entire axial length from a proximal end (inlet) to a distal end (outlet). Various embodiments of honeycomb bodies and methods for forming such honeycomb bodies will be described herein with specific reference to the appended drawings.

The material preferably comprises a filtration material, and in some embodiments comprises an inorganic layer. According to one or more embodiments, the inorganic layer provided herein comprises a discontinuous deposit formation disposed axially from the inlet end to the outlet end comprising discrete and disconnected patches of material or filtration material and binder comprised of primary particles in secondary aggregate particles or agglomerates that are substantially spherical. In one or more embodiments, the primary particles are non-spherical. In one or more embodiments, “substantially spherical” refers to an agglomerate having a circularity in cross section in a range of from about 0.8 to about 1 or from about 0.9 to about 1, with 1 representing a perfect circle. In one or more embodiments, 75% of the primary particles deposited on the honeycomb body have a circularity of less than 0.8. In one or more embodiments, the aggregate particles or agglomerates deposited on the honeycomb body have an average circularity greater than 0.9, greater than 0.95, greater than 0.96, greater than 0.97, greater than 0.98, or greater than 0.99.

Circularity can be measured using a scanning electron microscope (SEM). The term “circularity of the cross-section (or simply circularity)” is a value expressed using the equation shown below. A circle having a circularity of 1 is a perfect circle. Circularity=(4π×cross-sectional area)/(length of circumference of the cross-section)².

In one or more embodiments, the “filtration material” provides enhanced filtration efficiency to the honeycomb body, both locally through and at the wall and globally through the honeycomb body. In one or more embodiments, “filtration material” is not catalytically active in that it does not react with components of a gaseous mixture of an exhaust stream at certain temperatures.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to”.

A honeycomb body, as referred to herein, comprises a shaped honeycomb structure of intersecting walls to form cells that define channels. The honeycomb structure may be formed, extruded, or molded, and may be of a selected shape or size. For example, a ceramic honeycomb structure may be a filter body formed from cordierite or other suitable ceramic material.

A honeycomb body, as referred to herein, may also comprise a shaped ceramic honeycomb structure having at least one layer applied to wall surfaces of a porous ceramic base portion of the honeycomb structure, which can be configured to filter particulate matter from a gas stream, such as by plugging or sealing certain channels to force gas flow through the porous walls. There may be more than one application or layer applied to the same location of the honeycomb structure. The layer may comprise inorganic material, organic material or both inorganic material and organic material. For example, a honeycomb body may, in one or more embodiments, be formed from cordierite or other ceramic material and have a porous inorganic layer applied to surfaces of the cordierite honeycomb structure.

A honeycomb body of one or more embodiments may comprise a honeycomb structure which serves as a base portion and deposited material such as a filtration material, which may be a porous inorganic layer disposed on one or more base portions of walls of the honeycomb structure. In some embodiments, the deposited material such as a filtration material, which may be a porous inorganic layer is applied to surfaces of base portions of the walls present within honeycomb structure, where the walls have surfaces that define a plurality of inner channels.

The inner channels may have various cross-sectional shapes, such as circles, ovals, triangles, squares, pentagons, hexagons, or tessellated combinations or any of these, for example, and may be arranged in a suitable geometric configuration. The inner channels may be discrete or intersecting and may extend through the honeycomb body from a first end thereof to a second end thereof, which is opposite the first end.

With reference now to FIG. 1, a honeycomb body 100 according to one or more embodiments shown and described herein is depicted. The honeycomb body 100 may, in embodiments, comprise a plurality of walls 115 defining a plurality of inner channels 110. The plurality of inner channels 110 and intersecting channel walls 115 extend between first end 105, which may be an inlet end, and second end 135, which may be an outlet end, of the honeycomb body.

In one or more embodiments, the honeycomb body may be formed from cordierite, aluminum titanate, enstatite, mullite, forsterite, corundum (SiC), spinel, sapphirine, or periclase, or combinations thereof. In general, cordierite is a solid phase solution having a composition according to the formula (Mg,Fe)₂Al₃(Si₅AlO₁₈). During manufacture, the pore size of the ceramic material may be controlled, the porosity of the ceramic material may be controlled, and the pore size distribution of the ceramic material may be controlled, for example by varying the particle sizes of the ceramic raw materials. In addition, pore formers may be included in ceramic batches used to form the honeycomb body and the pore structure.

In some embodiments, walls of the honeycomb body may have an average thickness from greater than or equal to 25 μm to less than or equal to 300 μm, such as from greater than or equal to 25 μm to less than or equal to 250 μm, greater than or equal to 45 μm to less than or equal to 230 μm, greater than or equal to 65 μm to less than or equal to 210 μm, greater than or equal to 65 μm to less than or equal to 190 μm, or greater than or equal to 85 μm to less than or equal to 170 μm.

The walls of the honeycomb body can be described to have a base portion comprised of a bulk portion (also referred to herein as the bulk), and deposited surface portions (also referred to herein as deposits or the inorganic deposit regions) disposed mostly or entirely on the surface of the base portion of the wall of the honeycomb body. The deposited surface portion (or inorganic deposit region) of the walls may extend from a surface of a base portion of a wall of the honeycomb body toward the center or bulk portion of the wall of the honeycomb body. The inorganic deposit region or deposited surface portion may extend from 0 (zero) to a depth of about 10 μm into the base portion of the wall of the honeycomb body. In some embodiments, the inorganic deposit region or deposited surface portion may extend about 5 μm, about 7 μm, or about 9 μm (i.e., a depth of 0 (zero)) into the base portion of the wall. The bulk portion of the honeycomb body constitutes the thickness of wall minus the deposited surface portions on both sides of the wall (where for example a deposited surface portion on the outlet side may be filtration material or catalytic material).

Thus, the bulk portion of the honeycomb body may be determined by the following equation:

t_{bulk}=tₜₒₜₐₗ−2t_{surface}

where t_{bulk} is the thickness of the bulk portion, tₜₒₜₐₗ is the total thickness of the wall and t_{surface} is the thickness of the wall surface deposits.

In one or more embodiments, the base portion of the honeycomb body (prior to applying any material or filtration material or layer) has a bulk median pore size from greater than or equal to 7 μm to less than or equal to 25 μm, such as from greater than or equal to 12 μm to less than or equal to 22 μm, or from greater than or equal to 12 μm to less than or equal to 18 μm. For example, in some embodiments, the base portion of the honeycomb body may have bulk median pore sizes of about 10 μm, about 11 μm, about 12 μm, about 13 μm, about 14 μm, about 15 μm, about 16 μm, about 17 μm, about 18 μm, about 19 μm, or about 20 μm. Generally, pore sizes of any given material typically exist in a statistical distribution. Thus, the term “median pore size” or “d₅₀” (prior to applying any material or filtration material or layer) refers to a length measurement, above which the pore sizes of 50% of the pores lie and below which the pore sizes of the remaining 50% of the pores lie, based on the statistical distribution of all the pores. Pores in ceramic bodies can be manufactured by at least one of: (1) inorganic batch material particle size and size distributions; (2) furnace/heat treatment firing time and temperature schedules; (3) furnace atmosphere (e.g., low or high oxygen and/or water content), as well as; (4) pore formers, such as, for example, polymers and polymer particles, starches, wood flour, hollow inorganic particles and/or graphite/carbon particles.

In specific embodiments, the median pore size (d₅₀) of the base portion of the honeycomb body (prior to applying any material or filtration material or layer) is in a range of from 10 μm to about 16 μm, for example 13-14 μm, and the d₁₀ refers to a length measurement, above which the pore sizes of 90% of the pores lie and below which the pore sizes of the remaining 10% of the pores lie, based on the statistical distribution of all the pores is about 7 μm. In specific embodiments, the d₉₀ refers to a length measurement, above which the pore sizes of 10% of the pores of the base portion of the honeycomb body (prior to applying any material or filtration material or layer) lie and below which the pore sizes of the remaining 90% of the pores lie, based on the statistical distribution of all the pores is about 30 μm. In specific embodiments, the median or average diameter (D₅₀) of the secondary aggregate particles or agglomerates is about 2 microns. In specific embodiments, it has been determined that when the agglomerate median size D₅₀ and the median wall pore size of the bulk honeycomb body d₅₀ is such that there is a ratio of agglomerate median size D₅₀ to median wall pore size of the bulk honeycomb body d₅₀ is in a range of from 5:1 to 16:1, excellent filtration efficiency results and low pressure drop results are achieved. In more specific embodiments, a ratio of agglomerate median size D₅₀ to median wall pore size of the base portion of honeycomb body d₅₀ (prior to applying any material or filtration material or layer) is in a range of from 6:1 to 16:1, 7:1 to 16:1, 8:1 to 16:1, 9:1 to 16:1, 10:1 to 16:1, 11:1 to 16:1 or 12:1 to 6:1 provide excellent filtration efficiency results and low pressure drop results.

In some embodiments, the base portion of the honeycomb body may have bulk porosities, not counting a coating, of from greater than or equal to 50% to less than or equal to 75% as measured by mercury intrusion porosimetry. Other methods for measuring porosity include scanning electron microscopy (SEM) and X-ray tomography, these two methods in particular are valuable for measuring surface porosity and bulk porosity independent from one another. In one or more embodiments, the bulk porosity of the honeycomb body may be in a range of from about 50% to about 75%, in a range of from about 50% to about 70%, in a range of from about 55% to about 70%, in a range of from about 60% to about 70%, in a range of from about 50% to about 65%, in a range of from about 50% to about 60%, in a range of from about 50% to about 58%, in a range of from about 50% to about 56%, or in a range of from about 50% to about 54%, for example.

In one or more embodiments, the inorganic deposit region of the honeycomb body has a surface median pore size from greater than or equal to 7 μm to less than or equal to 30 μm, such as from 10 μm to less than or equal to 25 μm, or 13 μm to less than or equal to 22 μm, or greater than or equal to 8 μm to less than or equal to 15 μm, or from greater than or equal to 10 μm to less than or equal to 14 μm. For example, in some embodiments, the inorganic deposit region of the honeycomb body may have surface median pore sizes of about 8 μm, about 9 μm, about 10 μm, about 11 μm, about 12 μm, about 13 μm, about 14 μm, or about 15 μm, or about 13-20 μm, or about 13-15 μm, or about 15-22 μm, or about 16-22 μm, or about 17-22 μm, or about 18-22 μm, or about 19-22 μm.

In some embodiments, the surface of the base portion of the honeycomb body may have surface porosities, prior to application of a layer, of from greater than or equal to 35% to less than or equal to 75% as measured by mercury intrusion porosimetry, SEM, or X-ray tomography. In one or more embodiments, the surface porosity of the base portion of the honeycomb body may be less than 65%, such as less than 60%, less than 55%, less than 50%, less than 48%, less than 46%, less than 44%, less than 42%, less than 40%, less than 48%, or less than 36% for example.

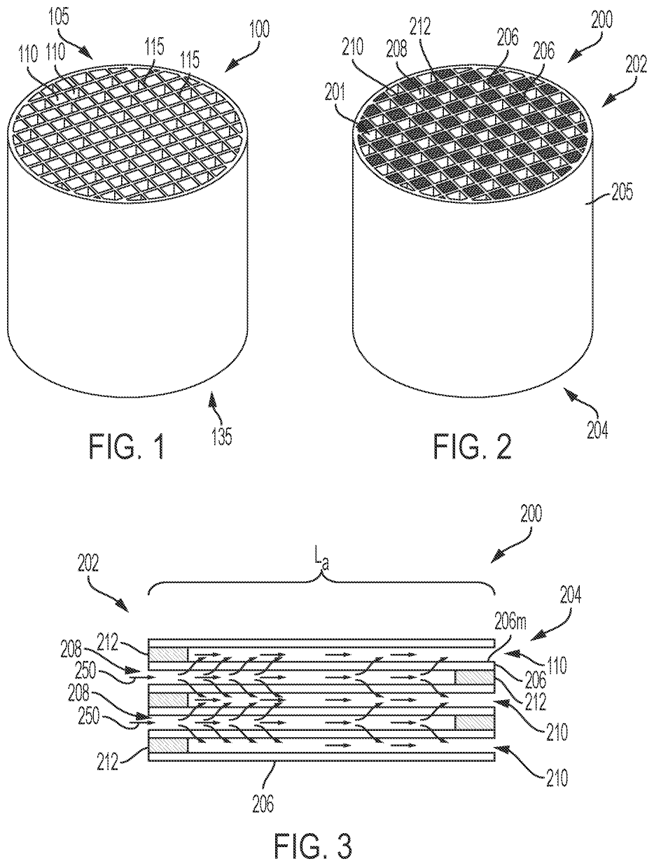

Referring now to FIGS. 2-3, a honeycomb body in the form of a particulate filter 200 is schematically depicted. The particulate filter 200 may be used as a wall-flow filter to filter particulate matter from a gas stream 250, such as an exhaust gas stream emitted from a gasoline engine, such as where the particulate filter 200 is a gasoline particulate filter or in other applications a diesel particulate filter. The particulate filter 200 generally comprises a honeycomb body having a plurality of channels 201 or cells which extend between an inlet end 202 and an outlet end 204, defining an overall axial length Lₐ (shown in FIG. 3). The channels 201 of the particulate filter 200 are formed by, and at least partially defined by a plurality of intersecting channel walls 206 that extend from the inlet end 202 to the outlet end 204. The particulate filter 200 may also include a skin layer 205 surrounding the plurality of channels 201. This skin layer 205 may be extruded during the formation of the channel walls 206 or formed in later processing as an after-applied skin layer, such as by applying a skinning cement to the outer peripheral portion of the channels.

A cross-sectional longitudinal view of the particulate filter 200 of FIG. 2 is shown in FIG. 3. In some embodiments, certain channels are designated as inlet channels 208 and certain other channels are designated as outlet channels 210. In some embodiments of the particulate filter 200, at least a first set of channels may be plugged with plugs 212. Generally, the plugs 212 are arranged proximate the ends (i.e., the inlet end or the outlet end) of the channels 201. The plugs are generally arranged in a pre-defined pattern, such as in the checkerboard pattern shown in FIG. 2, with every other channel being plugged at an end. The inlet channels 208 may be plugged at or near the outlet end 204, and the outlet channels 210 may be plugged at or near the inlet end 202 on channels not corresponding to the inlet channels, as depicted in FIG. 3. Accordingly, each cell may be plugged at or near one end of the particulate filter only. The intersecting channel walls 206 are porous such that the gas stream 250 flows through a thickness of the walls, as well as in an axial direction, and overall in the direction of the arrows, from inlet channels 208 to the outlet channels 210. The porous ceramic walls have an average wall thickness. A midpoint 206m is one-half of the average wall thickness.

While FIG. 2 generally depicts a checkerboard plugging pattern, it should be understood that alternative plugging patterns may be used in the porous ceramic honeycomb article. In the embodiments described herein, the particulate filter 200 may be formed with a channel density of up to about 600 channels per square inch (cpsi). For example, in some embodiments, the particulate filter 100 may have a channel density in a range from about 100 cpsi to about 600 cpsi. In some other embodiments, the particulate filter 100 may have a channel density in a range from about 100 cpsi to about 400 cpsi or even from about 200 cpsi to about 300 cpsi.

In the embodiments described herein, the channel walls 206 of the particulate filter 200 may have a thickness of greater than about 4 mils (101.6 microns). For example, in some embodiments, the thickness of the channel walls 206 may be in a range from about 4 mils up to about 30 mils (762 microns). In some other embodiments, the thickness of the channel walls 206 may be in a range from about 7 mils (177.8 microns) to about 20 mils (508 microns).

In some embodiments of the particulate filter 200 described herein the channel walls 206 of the particulate filter 200 may have a bare open porosity (i.e., the porosity before any coating is applied to the honeycomb body) % P≥35% prior to the application of any coating to the particulate filter 200. In some embodiments the bare open porosity of the channel walls 206 may be such that 40%≤% P≤75%. In other embodiments, the bare open porosity of the channel walls 206 may be such that 45%≤% P≤75%, 50%≤% P≤75%, 55%≤% P≤75%, 60%≤% P≤75%, 45%≤% P≤70%, 50%≤% P≤70%, 55%≤% P≤70%, or 60%≤% P≤70%.

Further, in some embodiments, the channel walls 206 of the particulate filter 200 are formed such that the pore distribution in the channel walls 206 has a median pore size of ≤30 microns prior to the application of any coatings (i.e., bare). For example, in some embodiments, the median pore size may be ≥8 microns and less than or ≤30 microns. In other embodiments, the median pore size may be ≥10 microns and less than or ≤30 microns. In other embodiments, the median pore size may be ≥10 microns and less than or ≤25 microns. In some embodiments, particulate filters produced with a median pore size greater than about 30 microns have reduced filtration efficiency while with particulate filters produced with a median pore size less than about 8 microns may be difficult to infiltrate the pores with a washcoat containing a catalyst. Accordingly, in some embodiments, it is desirable to maintain the median pore size of the channel wall in a range of from about 8 microns to about 30 microns, for example, in a range of from 10 microns to about 20 microns.

In one or more embodiments described herein, the honeycomb body of the particulate filter 200 is formed from a metal or ceramic material such as, for example, cordierite, silicon carbide, aluminum oxide, aluminum titanate or any other ceramic material suitable for use in elevated temperature particulate filtration applications. For example, the particulate filter 200 may be formed from cordierite by mixing a batch of ceramic precursor materials which may include constituent materials suitable for producing a ceramic article which predominately comprises a cordierite crystalline phase. In general, the constituent materials suitable for cordierite formation include a combination of inorganic components including talc, a silica-forming source, and an alumina-forming source. The batch composition may additionally comprise clay, such as, for example, kaolin clay. The cordierite precursor batch composition may also contain organic components, such as organic pore formers, which are added to the batch mixture to achieve the desired pore size distribution. For example, the batch composition may comprise a starch which is suitable for use as a pore former and/or other processing aids. Alternatively, the constituent materials may comprise one or more cordierite powders suitable for forming a sintered cordierite honeycomb structure upon firing as well as an organic pore former material.

The batch composition may additionally comprise one or more processing aids such as, for example, a binder and a liquid vehicle, such as water or a suitable solvent. The processing aids are added to the batch mixture to plasticize the batch mixture and to generally improve processing, maintain shape, reduce the drying time, reduce cracking upon firing, and/or aid in producing the desired properties in the honeycomb body. For example, the binder can include an organic binder. Suitable organic binders include water soluble cellulose ether binders such as methylcellulose, hydroxypropyl methylcellulose, methylcellulose derivatives, hydroxyethyl acrylate, polyvinylalcohol, and/or any combinations thereof. Incorporation of the organic binder into the plasticized batch composition allows the plasticized batch composition to be readily extruded and/or to maintain shape of the extrudate. In embodiments, the batch composition may include one or more optional forming or processing aids such as, for example, a lubricant which assists in the extrusion of the plasticized batch mixture. Exemplary lubricants can include tall oil, sodium stearate or other suitable lubricants.

After the batch of ceramic precursor materials is mixed with the appropriate processing aids, the batch of ceramic precursor materials is extruded and dried to form a self-standing green honeycomb body comprising an inlet end and an outlet end with a plurality of channel walls extending between the inlet end and the outlet end. Thereafter, the green honeycomb body is fired according to a firing schedule suitable for producing a fired honeycomb body. At least a first set of the channels of the fired honeycomb body are then plugged in a predefined plugging pattern with a plugging composition such as a ceramic plugging composition and the fired honeycomb body is again fired to fuse or calcine or ceram the plugs and secure the plugs in the channels.

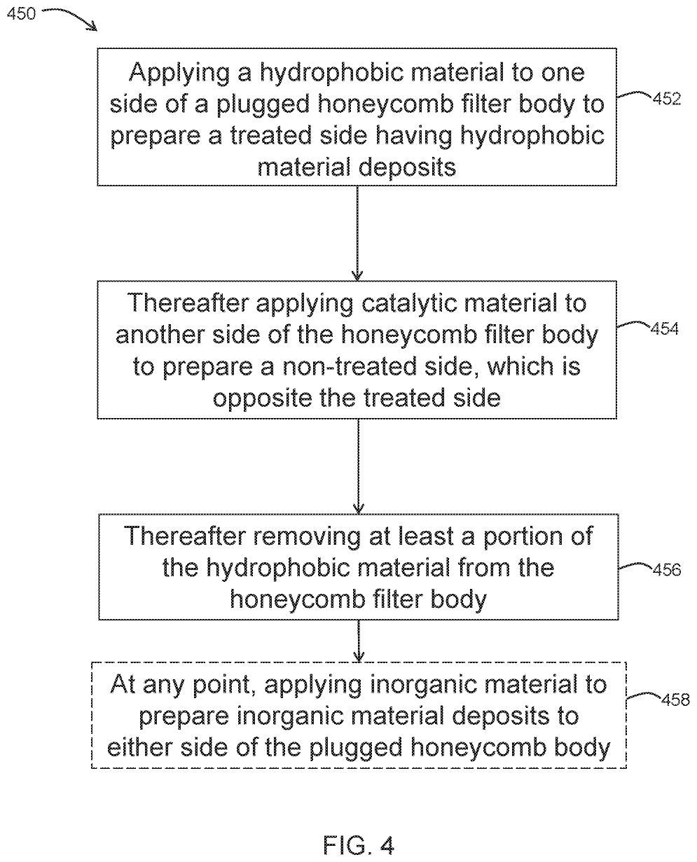

Generally, with respect to FIG. 4, a method 450 for preparing fluid treatment articles herein, comprises operations 452 to 458. At operation 452, a hydrophobic material is applied at one side of a plugged honeycomb filter body to prepare a treated side having hydrophobic material deposits. The side to which the hydrophobic material is applied is the “treated” side. The hydrophobic material forms hydrophobic material deposits at the treated side. The plugged honeycomb body includes intersecting porous walls and a plurality of channels comprised of inlet channels which are plugged at a distal end of the plugged honeycomb filter body and outlet channels which are plugged at a proximal end of the plugged honeycomb filter body. The porous walls comprise: porous ceramic base portions with a plurality of pores and an average thickness and having inlet sides and outlet sides, inlet surfaces defining the inlet channels; and outlet surfaces defining the outlet channels.

In one or more embodiments, the honeycomb filter body has bare surfaces and pores prior to the surface treatment. In one or more embodiments, the hydrophobic material is applied to the inlet surfaces of the porous ceramic base portions. In one or more embodiments, the hydrophobic material is applied to the outlet surfaces of the porous ceramic base portions.

In embodiments, applying the hydrophobic material further comprises exposing only one of an inlet side or an outlet side of a plugged honeycomb filter body to an organic material or a mixture of organic and inorganic materials.

In embodiments, applying the hydrophobic material further comprises infiltrating a mixture of particles of the organic material or the mixture of organic and inorganic materials and a liquid vehicle under vacuum to apply hydrophobic material deposits at only one of the inlet side or the outlet side.

At operation 454, after the hydrophobic material is applied, catalytic material is applied at the side of the plugged honeycomb filter body opposite that of the hydrophobic material. The side to which the catalytic material is applied is the opposite side which is not treated with a hydrophobic material, i.e. a “non-treated” side. In one or more embodiments, when the hydrophobic material is applied to the inlet surfaces of the porous ceramic base portions, the catalytic material is applied to the outlet surfaces of the ceramic base portions. In one or more embodiments, when the hydrophobic material is applied to the outlet surfaces of the porous ceramic base portions, the catalytic material is applied to the inlet surfaces of the ceramic base portions. In one or more embodiments, the inlet surfaces of the porous ceramic base portions are free of the catalytic material.

In one or more embodiments, the catalytic material is applied by coating the catalytic material. In one or more embodiments, the catalytic material is applied as a slurry. With respect to at an outlet side refers to on or within walls defining the outlet channels of the plugged honeycomb body.

In one or more embodiments, penetrability of the catalytic material into the porous ceramic base portions is reduced by the presence of the hydrophobic material. In one or more of the following: increasing slurry viscosity, increasing slurry particle size of the catalytic material, and increasing concentration of the catalytic material in the slurry.

At operation 456, after applying the catalytic material, at least a portion of the hydrophobic material is removed from the honeycomb filter body. In one or more embodiments, all of the hydrophobic material is removed from the honeycomb filter body.

In one or more embodiments, the hydrophobic material is removed from the honeycomb filter body by heating the honeycomb filter body. In some embodiments, the heating of the honeycomb filter body causes residual material to remain in the honeycomb filter body. The residual material can comprise char and/or soot resulting from heating of the hydrophobic material. The residual material can comprise inorganic particles resulting from heating of the hydrophobic material.

In one or more embodiments, all or at least a portion of the hydrophobic material is burned off at a temperature of greater than or equal to 400° C. In one or more embodiments, the temperature is in a range of greater than or equal to 500° C. to less than or equal to 600° C., including all values and subranges therebetween.

In embodiments, the methods herein further comprise calcining the catalytic material. In one or more embodiments, at least a portion of the hydrophobic material is removed from the honeycomb filter body during the calcining. In one or more embodiments, all of the hydrophobic material is removed from the honeycomb filter body during the calcining.

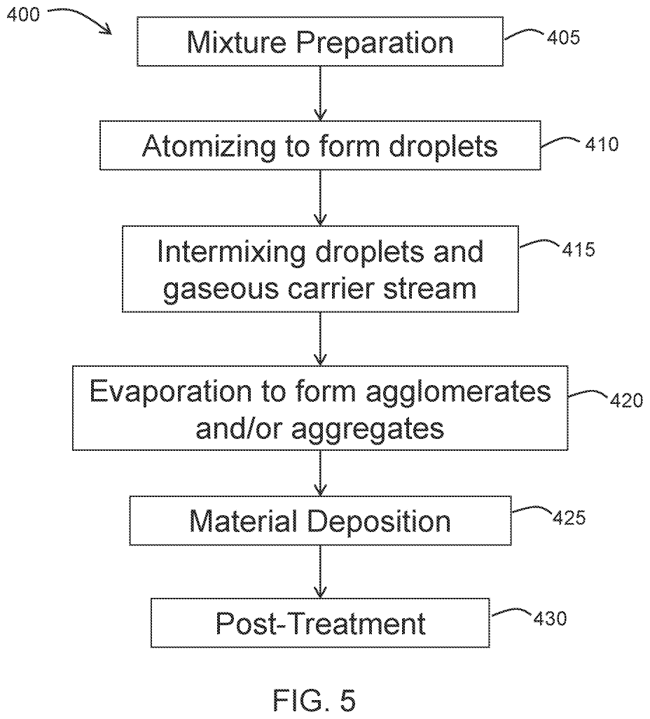

At any point during the process, according to operation 458, particles of an inorganic material are applied or disposed at one side of porous ceramic base portions of porous walls of the plugged honeycomb body. Disposed at inlet sides refers to on or within walls defining the inlet channels of the plugged honeycomb body. Disposed at outlet sides refers to on or within walls defining the outlet channels of the plugged honeycomb body. FIG. 5 provides an exemplary process flow 400 for methods of applying inorganic material.

In one or more embodiments, after applying the hydrophobic material, an inorganic material is applied to the treated sides. In one or more embodiments, after applying the hydrophobic material, an inorganic material is applied to the non-treated sides.

In one or more embodiments, after the applying the hydrophobic material and before applying the catalytic material, an inorganic material is applied to the treated sides. In one or more embodiments, after the applying the hydrophobic material and before applying the catalytic material, an inorganic material is applied to the non-treated sides.

In one or more embodiments, after removing the hydrophobic material from the honeycomb filter body, an inorganic material is applied at the treated sides where the hydrophobic material had been applied.

FIG. 6 schematically depicts a cross-sectional view of a section of a porous wall of a honeycomb body including a catalytic material loaded in the pores (prior art). A porous wall 310 of a honeycomb body made of ceramic structure 315, including a catalytic material 320 loaded in and on the pores 305. The catalytic material 320 is distributed throughout a thickness of a porous ceramic base portion 325 of the porous wall 310. Gaseous flow 300 travels in the direction of the arrows, which is exemplified for the large pores. This porous wall is not subject to a surface treatment prior to application of the catalytic material.

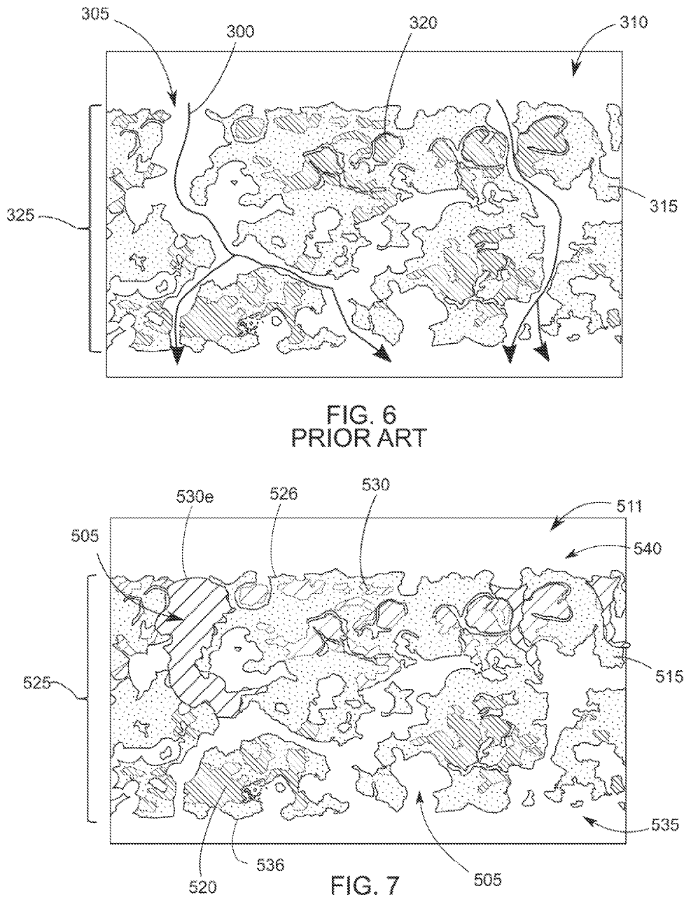

FIG. 7 is a cross-sectional schematic view of a portion of a porous wall 511 according to embodiments disclosed herein. The porous wall 511 comprises a porous ceramic base portion 525 with a plurality of pores 505 and a ceramic structure 515. An average thickness of the porous ceramic base portion 525 may be determined by an overall average thickness (all porous ceramic base portions in the honeycomb body) along entire axial length from a proximal end (inlet) to a distal end (outlet). The porous ceramic base portion 525 comprises an inlet side 540 having an inlet surface, and an outlet side 535 having an outlet surface. In this embodiment, hydrophobic material deposits 530 are disposed at the inlet side 540 in the pores 505. In this embodiment, the inlet surface is comprised of exposed hydrophobic material 530e and exposed surfaces 526 of the ceramic base portion 525 at the inlet side 540. A combination of the inlet surfaces of all of the porous walls of the honeycomb body define the inlet channels of the honeycomb body.

In this embodiment, catalytic material 520 is disposed at the outlet side 535. In this embodiment, the outlet surface is comprised of exposed areas 536 of a second (outlet side) surface of the ceramic base portion 525. In this embodiment, the catalytic material 520 is in pores 505 of the ceramic base portion 525 at the outlet side 535.

A deposited surface portion or hydrophobic material deposit region extends from a first (inlet side) surface 526 of the porous ceramic base portion 525 toward a center or bulk portion region of the porous ceramic base portion 525.

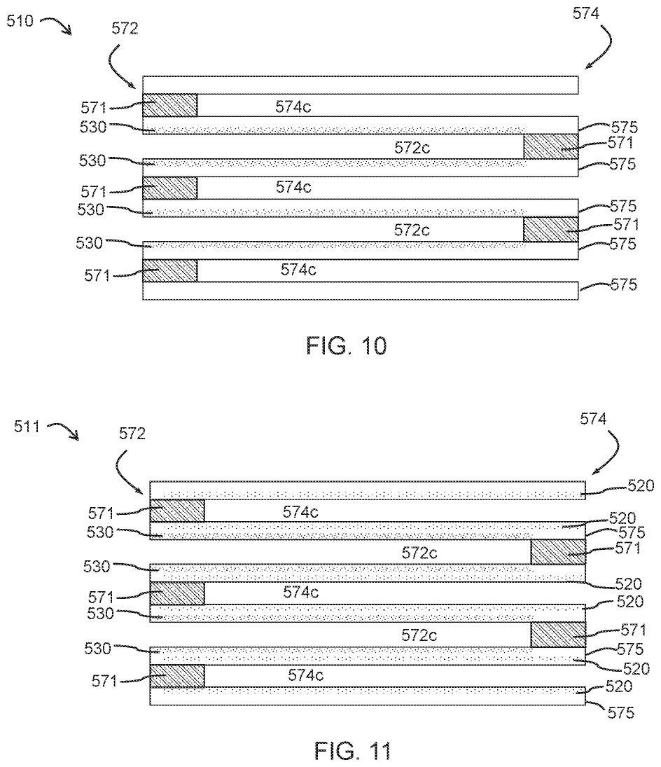

In some embodiments, an article is prepared with the hydrophobic material deposits only at one side, the treated side. Then, a coater applies catalytic material to the other side, the non-treated side, of such article. Embodiments herein include an article with only the hydrophobic material deposits only at one side (e.g., FIG. 10), and an article with both the hydrophobic material deposits only at one side and the catalytic material at the other side (e.g., FIGS. 7 and 11).

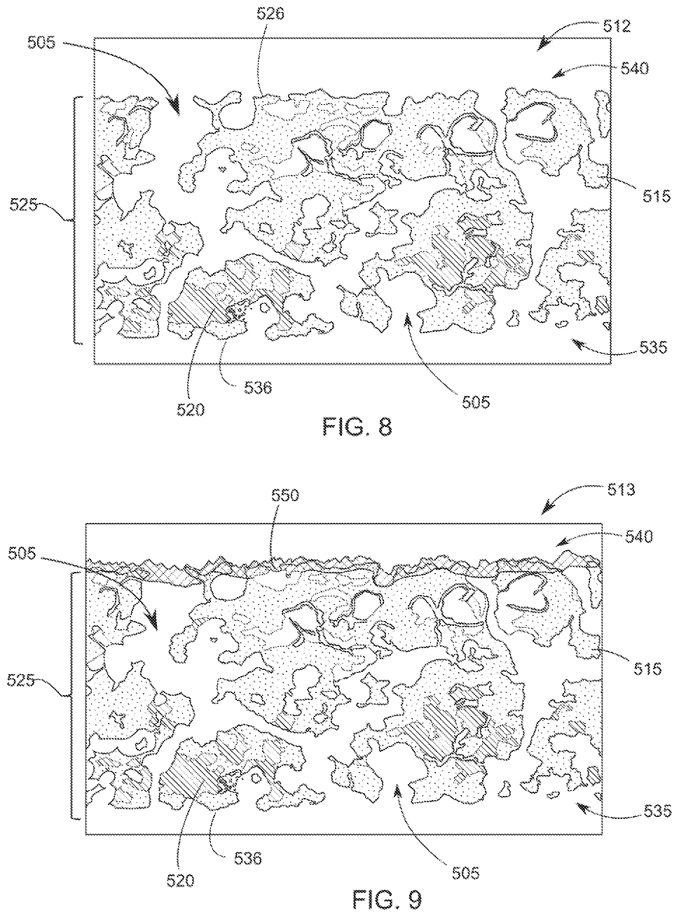

FIG. 8 is the cross-sectional schematic view of the portion of the porous wall of FIG. 7 and after removal of the hydrophobic material deposits in accordance with one or more embodiments herein. The porous wall 512 comprises the porous ceramic base portion 525 with a plurality of pores 505 and a ceramic structure 515. The porous ceramic base portion 525 comprises an inlet side 540 having an inlet surface, and an outlet side 535 having an outlet surface. In this embodiment, upon removal of the hydrophobic material deposits more pores 505 relative to FIG. 7 are devoid of material. In this embodiment, the inlet surface is comprised of exposed surfaces 526 of the ceramic base portion 525 at the inlet side 540.

The catalytic material 520 is disposed at the outlet side 535. In this embodiment, the outlet surface is comprised of exposed areas 536 of a second (outlet side) surface of the ceramic base portion 525. In this embodiment, the catalytic material 520 is in pores 505 of the ceramic base portion 525 at the outlet side 535.

FIG. 9 is the cross-sectional schematic view of the portion of the porous wall of FIG. 7 and after removal of the hydrophobic material deposits further including inorganic deposits deposited onto the walls in accordance with one or more embodiments herein. The porous wall 513 comprises the porous ceramic base portion 525 with a plurality of pores 505 and a ceramic structure 515. The porous ceramic base portion 525 comprises an inlet side 540 having an inlet surface, and an outlet side 535 having an outlet surface. In this embodiment, upon removal of the hydrophobic material deposits more pores 505 relative to FIG. 7 are devoid of material. In this embodiment, inorganic deposits 550 are at the inlet side 540. In this embodiment, the inlet surface is comprised of exposed surfaces of the inorganic deposits 550. In this embodiment, the inorganic deposits 550 were added before removal of the hydrophobic material resulting in minimal ingress of the inorganic deposits 550 into the pores 505 of the inlet side 540.

The catalytic material 520 is disposed at the outlet side 535. In this embodiment, the outlet surface is comprised of exposed areas 536 of a second (outlet side) surface of the ceramic base portion 525. In this embodiment, the catalytic material 520 is in pores 505 of the ceramic base portion 525 at the outlet side 535.

FIG. 10 is an axial cross-sectional schematic view of a section of a porous wall 510 of an article according to embodiments disclosed herein. In one or more embodiments, the article is effective for further coating of one or more materials such as hydrophobic material, and other inorganic material for use for filtration of particulates from gaseous streams and/or for catalytically converting combustion by-products. In accordance with FIG. 10, application of hydrophobic material deposits 530 is specific to wall flow particulate filters, which have inlet channels 572c which are plugged with plugs 571 at a distal end 574 of the plugged honeycomb filter body and outlet channels 574c which are plugged with plugs 571 at a proximal end 572 of the plugged honeycomb filter body. An article may be used as an article to treat an exhaust gas stream, such as an exhaust gas stream emitted from a gasoline engine, which enters the article at a first/inlet/proximal end 572 and travels along a plurality of the inlet channels 572c, through walls 575, and exits along a plurality of the outlet channels 574c at a second/outlet/distal end 574. In this embodiment, the hydrophobic material deposits 530 are in the walls 575 of the inlet channels 572c. In one or more embodiments, there is no hydrophobic material deposits at the walls of the outlet channels 574c.

It is understood that other embodiments may locate the hydrophobic material deposits 530 in the walls 575 of the outlet channels, and there is no hydrophobic material deposits at the walls 575 of the inlet channels.

FIG. 11 is an axial cross-sectional schematic view of a section of a porous wall 511 of an article according to embodiments disclosed herein. In one or more embodiments, the article is effective for further processing and/or coating of one or more materials such as other inorganic material for filtration of particulates from gaseous streams and/or for catalytically converting combustion by-products. In accordance with FIG. 11, and as shown in FIG. 10, the hydrophobic material deposits 530 are in the walls 575 of the inlet channels 572c, which are plugged with plugs 571 at a distal end 574 of the plugged honeycomb filter body, and catalytic material 520 is at the walls of the outlet channels 574c, which are plugged with plugs 571 at a proximal end 572 of the plugged honeycomb filter body.

It is understood that other embodiments may locate the hydrophobic material deposits 530 in the walls 575 of the outlet channels, and the catalytic material 520 at the walls 575 of the inlet channels.

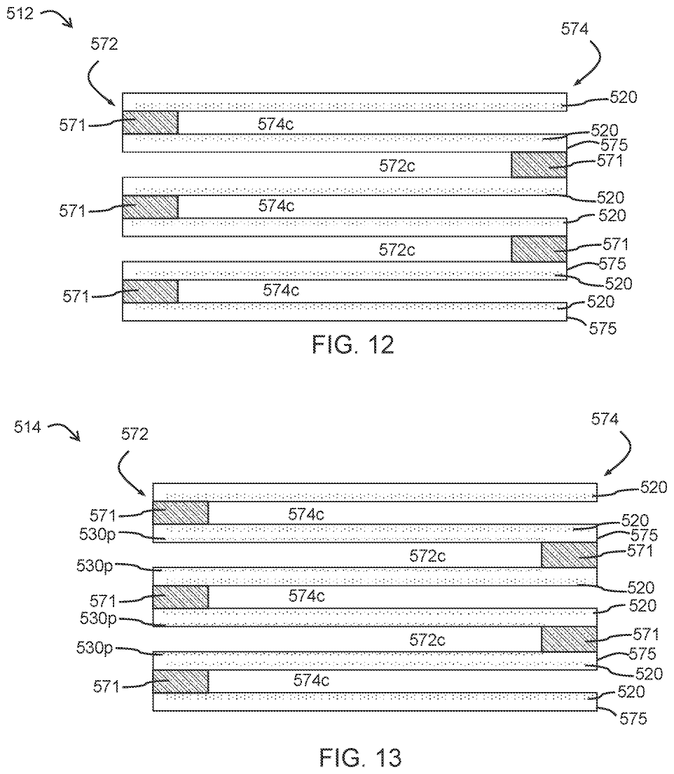

FIG. 12 is an axial cross-sectional schematic view of a section of a porous wall 512 of an article according to embodiments disclosed herein. In one or more embodiments, the article is effective for filtration of particulates from gaseous streams and/or for catalytically converting combustion by-products. In accordance with FIG. 12, the hydrophobic material deposits present in FIGS. 10-11 has been removed by techniques discussed herein. The article including the porous wall of FIG. 12 may be used as an article to treat an exhaust gas stream, such as an exhaust gas stream emitted from a gasoline engine, which enters the article at a first/inlet/proximal end 572 and travels along a plurality of the inlet channels 572c, through walls 575, and exits along a plurality of the outlet channels 574c at a second/outlet/distal end 574. In this embodiment, catalytic material 520 is in the walls 575 of the outlet channels 574c. In this embodiment, all of the hydrophobic material deposits has been removed.

It is understood that other embodiments may locate the catalytic material deposits 520 in the walls 575 of the inlet channels.

FIG. 13 is an axial cross-sectional schematic view of a section of a porous wall 514 of an article according to embodiments disclosed herein. In one or more embodiments, the article is effective for filtration of particulates from gaseous streams and/or for catalytically converting combustion by-products. In accordance with FIG. 13, the hydrophobic material deposits present in FIGS. 10-11 has been removed by techniques discussed herein. The article including the porous wall of FIG. 13 may be used as an article to treat an exhaust gas stream, such as an exhaust gas stream emitted from a gasoline engine, which enters the article at a first/inlet/proximal end 572 and travels along a plurality of the inlet channels 572c, through walls 575, and exits along a plurality of the outlet channels 574c at a second/outlet/distal end 574. In this embodiment, catalytic material 520 is in the walls 575 of the outlet channels 574c. In this embodiment, a portion of the hydrophobic material deposits 530 has been removed relative to FIGS. 10-11, and a portion of the hydrophobic material deposits 530p remains.

It is understood that other embodiments may locate the catalytic material deposits 520 in the walls 575 of the inlet channels and a portion of the hydrophobic material deposits 530p remains in the outlet channels.

As discussed with respect to FIG. 9, in various embodiments, inorganic material in the form of deposits may be further included, the inorganic material being effective to filter particulate matter from a gas stream, for example, an exhaust gas stream from a gasoline engine. Accordingly, the median pore size, porosity, geometry and other design aspects of both the bulk and the surfaces of the base portions of the honeycomb body are selected taking into account these filtration requirements of the honeycomb body. Particles of the inorganic material that are deposited on the base portion of the wall of the honeycomb body and help prevent particulate matter, such as, for example, soot and ash, from exiting the honeycomb body and to help accelerate the buildup of particulate matter and therefore the filtration efficiency without clogging the base portion of the walls of the honeycomb body. In this way, and according to embodiments, the inorganic deposits can serve as an enhanced filtration component while the porous ceramic walls of the honeycomb body also provide filtration and can be configured to otherwise minimize pressure drop for example as compared to conventional honeycomb bodies without such layer. As will be described in further detail herein, the inorganic deposit regions may be formed by a suitable method, such as, for example, an aerosol deposition method. Aerosol deposition enables the formation porous deposits which may be in the form of a thin, porous layer on at least some areas of the walls of the honeycomb body.

According to one or more embodiments, a process is disclosed herein which comprises forming an aerosol with a binder process, which is deposited on a honeycomb body to provide a high filtration efficiency material, which may be an inorganic layer, on the honeycomb body to provide a particulate filter. According to one or more embodiments, the process can comprise the steps of mixture preparation, atomization, drying, and deposition of material on the walls of a wall flow filter and heat treatment to effect curing or fusing. In some embodiments the inorganic deposits be imparted with a high mechanical integrity even without sintering steps (e.g., heating to temperatures in excess of 1000° C.) by aerosol deposition with binder, although in other embodiments the deposits may be sintered.

According to one or more embodiments, an exemplary process flow 400 according to FIG. 5 for coating particles of an inorganic material on one or more portions of porous ceramic walls of a honeycomb body according to FIG. 4 at operation 458 includes: mixture preparation 405, atomizing to form droplets 410, intermixing droplets and a gaseous carrier stream 415; evaporating liquid vehicle to form agglomerates and/or aggregates 420, depositing of material, e.g., agglomerates, on the walls of a wall-flow filter 425, and optional post-treatment 430 to, for example, bind the material on, or in, or both on and in, the porous walls of the honeycomb body. Aerosol deposition methods form of agglomerates comprising a binder can provide a high mechanical integrity even without any high temperature curing steps (e.g., heating to temperatures in excess of 1000° C.), and in some embodiments even higher mechanical integrity after a curing step such as a high temperature (e.g., heating to temperatures in excess of 1000° C.) curing step.

Mixture preparation 405. Inorganic particles can be used as a raw material in a mixture for depositing. According to one or more embodiments, the particles are selected from Al₂O₃, SiO₂, TiO₂, CeO₂, ZrO₂, SiC, MgO and combinations thereof. In one or more embodiments, the mixture is a suspension. The particles may be supplied as a raw material suspended in a liquid vehicle to which a further liquid vehicle is optionally added.

In some embodiments, the suspension is aqueous-based, and in other embodiments, the suspension is organic-based, for example, an alcohol such as ethanol or methanol.

The solution is formed using a solvent which is added to dilute the suspension if needed. Decreasing the solids content in the solution could reduce the aggregate size proportionally if the droplet generated by atomizing has similar size. The solvent should be miscible with suspension mentioned above, and be a solvent for binder and other ingredients.

A binder is optionally added to reinforce the starting material for forming agglomerates, which comprises inorganic binder, to provide mechanical integrity to deposited material, including after deposition. The binder preferably provides binding strength between particles after exposure to elevated temperature (>500° C.). The starting material can include both inorganic and organic components. After exposure to high temperature in excess of about 150° C., the organic component will preferably decompose or react with moisture and oxygen in the air. Suitable binders include but are not limited to alkoxy-siloxane resins. In one or more embodiments, the alkoxy-siloxane resins are reactive during processing. An exemplary reactive alkoxy-siloxane resin (methoxy functional) prior to processing has a specific gravity of 1.1 at 25° C. Another exemplary reactive alkoxy-siloxane resin (methyl-methoxy functional) prior to processing has a specific gravity of 1.155 at 25° C.

Catalyst can be added to accelerate the cure reaction of binder. A catalyst that can be used to accelerate the cure reaction of reactive alkoxy-siloxane resins is titanium butoxide.

Atomizing to form droplets 410. The mixture is atomized into fine droplets by high pressure gas through a nozzle. The atomizing gas contributes to breaking up the liquid-particulate-binder stream into the droplets. The pressure of the atomizing gas is in the range of 20 psi to 150 psi. The pressure of the liquid is in the range of 1 to 100 psi. The average droplet size according to one or more embodiments is in the range of from 1 micrometer to 40 micrometer s, for example, in a range of from 5 micrometer s to 10 micrometer s. The droplet size can be adjusted by adjusting the surface tension of the solution, viscosity of the solution, density of the solution, gas flow rate, gas pressure, liquid flow rate, liquid pressure, and/or nozzle design. In one or more embodiments, the atomizing gas comprises air, nitrogen or mixture thereof. In specific embodiments, the atomizing gas and the apparatus does not comprise air.

Intermixing droplets and gaseous carrier stream 415. The droplets are conveyed toward the honeycomb body by a gaseous carrier stream. In one or more embodiments, the gaseous carrier stream comprises a carrier gas and the atomizing gas. In one or more embodiments, at least a portion of the carrier gas contacts the atomizing nozzle. In one or more embodiments, substantially all of the liquid vehicle is evaporated from the droplets to form agglomerates comprised of the particles and the binder material.

In one or more embodiments, the gaseous carrier stream is heated prior to being mixed with the droplets. In one or more embodiments, the gaseous carrier stream is at a temperature in the range of from greater than or equal to 50° C. to less than or equal to 500° C., including all greater than or equal to 80° C. to less than or equal to 300° C., greater than or equal to 50° C. to less than or equal to 150° C., and all values and subranges therebetween. Operationally, temperature can be chosen to at least evaporate solvent of the mixture or suspension so long as the final temperature is above the dew point. As non-limiting example, ethanol can be evaporated at a low temperature. Without being held to theory, it is believed that an advantage of a higher temperature is that the droplets evaporate faster and when the liquid is largely evaporated, they are less likely to stick when they collide. In certain embodiments, smaller agglomerates contribute to better filtration material deposits formation. Furthermore, it is believed that if droplets collide but contain only a small amount of liquid (such as only internally), the droplets may not coalesce to a spherical shape. In some embodiments, non-spherical agglomerates may provide desirable filtration performance.

Evaporation to Form Agglomerates 420. To avoid liquid capillary force impact which may form non-uniform material which may result in high pressure drop penalty, the droplets are dried in an evaporation section of the apparatus, forming dry solid agglomerates, which may be referred to as secondary particles, or “microparticles” which are made up of primary nanoparticles and binder-type material. The liquid vehicle, or solvent, is evaporated and passes through the honeycomb body in a gaseous or vapor phase so that liquid solvent residual or condensation is minimized during material deposition. When the agglomerate is carried into the honeycomb body by gas flow, the residual liquid in the inorganic material should be less than 10 wt %. All liquid is preferably evaporated as a result of the drying and are converted into a gas or vapor phase. The liquid residual could include solvent in the mixture (such as ethanol in the examples), or water condensed from the gas phase. Binder is not considered as liquid residual, even if some or all of the binder may be in liquid or otherwise non-solid state before cure. In one or more embodiments, a total volumetric flow through the chamber is greater than or equal to 5 Nm³/hour and/or less than or equal to 200 Nm³/hour; including greater than or equal to 20 Nm³/hour and/or less than or equal to 100 Nm³/hour; and all values and subranges therebetween. Higher flow rates can deposit more material than lower flow rates. Higher flow rates can be useful as larger cross-sectional area filters are to be produced. Larger cross-sectional area filters may have applications in filter systems for diesel exhaust, building or outdoor filtration systems.

Deposition in honeycomb body 425. The secondary particles or agglomerates of the primary particles are carried in gas flow, and the secondary particles or agglomerates, and/or aggregates thereof, are deposited on inlet wall surfaces of the honeycomb body when the gas passes through the honeycomb body. In one or more embodiments, the agglomerates and/or aggregates thereof are deposited onto the porous walls of the plugged honeycomb body. The deposited agglomerates may be disposed on, or in, or both on and in, the porous walls. In one or more embodiments, the plugged honeycomb body comprises inlet channels which are plugged at a distal end of the honeycomb body, and outlet channels which are plugged at a proximal end of the honeycomb body. In one or more embodiments, the agglomerates and/or aggregates thereof are deposited on, or in, or both on and in, the walls defining the inlet channels.

The flow can be driven by a fan, a blower and/or a vacuum pump. Additional air can be drawn into the system to achieve a desired flow rate. A desired flow rate is in the range of 5 to 200 m³/hr.

One exemplary honeycomb body is suitable for use as a gasoline particular filter (GPF), and has the following non-limiting characteristics: diameter of 4.055 inches (10.3 cm), length of 5.47 inches (13.9 cm), cells per square inch (CPSI) of 200, wall thickness of 8 mils (203 microns), and average pore size of 14 μm.

In one or more embodiments, the average diameter of the secondary particles or agglomerates is in a range of from 300 nm micron to 10 microns, 300 nm to 8 microns, 300 nm micron to 7 microns, 300 nm micron to 6 microns, 300 nm micron to 5 microns, 300 nm micron to 4 microns, or 300 nm micron to 3 microns. In specific embodiments, the average diameter of the secondary particles or agglomerates is in the range of 1.5 microns to 3 microns, including about 2 microns. The average diameter of the secondary particles or agglomerates can be measured by a scanning electron microscope. Preferably most of the agglomerates are spherical. Aggregates of agglomerates may be spherical or non-spherical.

In one or more embodiments, the average diameter of the secondary particles or agglomerates is in a range of from 300 nm to 10 microns, 300 nm to 8 microns, 300 nm to 7 microns, 300 nm to 6 microns, 300 nm to 5 microns, 300 nm to 4 microns, or 300 nm to 3 microns, including the range of 1.5 microns to 3 microns, and including about 2 microns, and there is a ratio in the average diameter of the secondary particles or agglomerates to the average diameter of the primary particles of in range of from about 2:1 to about 67:1; about 2:1 to about 9:1; about 2:1 to about 8:1; about 2:1 to about 7:1; about 2:1 to about 6:1; about 2:1 to about 5:1; about 3:1 to about 10:1; about 3:1 to about 9:1; about 3:1 to about 8:1; about 3:1 to about 7:1; about 3:1 to about 6:1; about 3:1 to about 5:1; about 4:1 to about 10:1; about 4:1 to about 9:1; about 4:1 to about 8:1; about 4:1 to about 7:1; about 4:1 to about 6:1; about 4:1 to about 5:1; about 5:1 to about 10:1; about 5:1 to about 9:1; about 5:1 to about 8:1; about 5:1 to about 7:1; or about 5:1 to about 6:1, and including about 10:1 to about 20:1.

In one or more embodiments, the depositing of the agglomerates and/or aggregates onto and/or into the porous walls further comprises passing the gaseous carrier stream through the porous walls of the honeycomb body, wherein the walls of the honeycomb body filter out at least some of the agglomerates and/or aggregates by trapping the filtered agglomerates or aggregates on or in the walls of the honeycomb body. In one or more embodiments, the depositing of the agglomerates or aggregates onto the porous walls comprises filtering the agglomerates from the gaseous carrier stream with the porous walls of the plugged honeycomb body.

Post-Treatment 430. A post-treatment may optionally be used to adhere the agglomerates to the honeycomb body, and/or to each other. That is, in one or more embodiments, at least some of the agglomerates adhere to the porous walls. In one or more embodiments, the post-treatment comprises heating and/or curing the binder when present according to one or more embodiments. In one or more embodiments, the binder material causes the agglomerates to adhere or stick to the walls of the honeycomb body as well as each other. In one or more embodiments, the binder material tackifies the agglomerates.

Depending on the binder composition, curing conditions may vary. According to some embodiments, a low temperature cure reaction is utilized, for example, at a temperature of ≤100° C. In some embodiments, the curing can be completed in the vehicle exhaust gas with a temperature ≤950° C. A calcination treatment is optional, which can be performed at a temperature ≤650° C. Exemplary curing conditions are: a temperature range of from 40° C. to 200° C. for 10 minutes to 48 hours.

In one or more embodiments, the porosity of the material, which may be an inorganic layer, disposed on the walls of the honeycomb body, as measured by mercury intrusion porosimetry, SEM, or X-ray tomography is in a range of from about 20% to about 95%, or from about 25% to about 95%, or from about 30% to about 95%, or from about 40% to about 95%, or from about 45% to about 95%, or from about 50% to about 95%, or from about 55% to about 95%, or from about 60% to about 95%, or from about 65% to about 95%, or from about 70% to about 95%, or from about 75% to about 95%, or from about 80% to about 95%, or from about 85% to about 95%, from about 30% to about 95%, or from about 40% to about 95%, or from about 45% to about 95%, or from about 50% to about 95%, or from about 55% to about 95%, or from about 60% to about 95%, or from about 65% to about 95%, or from about 70% to about 95%, or from about 75% to about 95%, or from about 80% to about 95%, or from about 85% to about 95%, or from about 20% to about 90%, or from about 25% to about 90%, or from about 30% to about 90%, or from about 40% to about 90%, or from about 45% to about 90%, or from about 50% to about 90%, or from about 55% to about 90%, or from about 60% to about 90%, or from about 65% to about 90%, or from about 70% to about 90%, or from about 75% to about 90%, or from about 80% to about 90%, or from about 85% to about 90%, or from about 20% to about 85%, or from about 25% to about 85%, or from about 30% to about 85%, or from about 40% to about 85%, or from about 45% to about 85%, or from about 50% to about 85%, or from about 55% to about 85%, or from about 60% to about 85%, or from about 65% to about 85%, or from about 70% to about 85%, or from about 75% to about 85%, or from about 80% to about 85%, or from about 20% to about 80%, or from about 25% to about 80%, or from about 30% to about 80%, or from about 40% to about 80%, or from about 45% to about 80%, or from about 50% to about 80%, or from about 55% to about 80%, or from about 60% to about 80%, or from about 65% to about 80%, or from about 70% to about 80%, or from about 75% to about 80%,

As mentioned above, the deposited material, which may be an inorganic layer, on or in walls of the honeycomb body is very thin compared to thickness of the base portion of the walls of the honeycomb body. As discussed herein, the deposited material, which may be an inorganic layer, on the honeycomb body can be formed by methods that permit the material to be applied to surfaces of walls of the honeycomb body in very thin layers. In embodiments, the average thickness of the material, which may be an inorganic layer, on the base portion of the walls of the honeycomb body is greater than or equal to 0.5 μm and less than or equal to 50 μm, or greater than or equal to 0.5 μm and less than or equal to 45 μm, greater than or equal to 0.5 μm and less than or equal to 40 μm, or greater than or equal to 0.5 μm and less than or equal to 35 μm, or greater than or equal to 0.5 μm and less than or equal to 30 μm, greater than or equal to 0.5 μm and less than or equal to 25 μm, or greater than or equal to 0.5 μm and less than or equal to 20 μm, or greater than or equal to 0.5 μm and less than or equal to 15 μm, greater than or equal to 0.5 μm and less than or equal to 10 μm.

As discussed above, the material, which may be an inorganic layer, can be applied to the walls of the honeycomb body by methods that permit the inorganic material, which may be an inorganic layer, to have a small median pore size. This small median pore size allows the material, which may be an inorganic layer, to filter a high percentage of particulate and prevents particulate from penetrating the base portion of the walls of the honeycomb and settling into the pores of the honeycomb body, as described above with reference to FIG. 4. The small median pore size of material, which may be an inorganic layer, according to embodiments increases the filtration efficiency of the honeycomb body. In one or more embodiments, the material, which may be an inorganic layer, on the walls of the honeycomb body has a median pore size from greater than or equal to 0.1 μm to less than or equal to 5 μm, such as from greater than or equal to 0.5 μm to less than or equal to 4 μm, or from greater than or equal to 0.6 μm to less than or equal to 3 μm. For example, in some embodiments, the material, which may be an inorganic layer, on the walls of the honeycomb body may have median pore sizes of about 0.5 μm, about 0.6 μm, about 0.7 μm, about 0.8 μm, about 0.9 μm, about 1 μm, about 2 μm, about 3 μm, or about 4 μm.

Although the material, which may be an inorganic layer, on the walls of the honeycomb body may, in embodiments, cover substantially 100% of the wall surfaces defining inner channels of the honeycomb body, in other embodiments, the material, which may be an inorganic layer, on the walls of the honeycomb body covers less than substantially 100% of the wall surfaces defining inner channels of the honeycomb body. For instance, in one or more embodiments, the material, which may be an inorganic layer, on the walls of the honeycomb body covers at least 70% of the wall surfaces defining inner channels of the honeycomb body, covers at least 75% of the wall surfaces defining inner channels of the honeycomb body, covers at least 80% of the wall surfaces defining inner channels of the honeycomb body, covers at least 85% of the wall surfaces defining inner channels of the honeycomb body, covers at least 90% of the wall surfaces defining inner channels of the honeycomb body, or covers at least 85% of the wall surfaces defining inner channels of the honeycomb body.

As described above with reference to FIGS. 2 and 3, the honeycomb body can have a first end and second end. The first end and the second end are separated by an axial length. In some embodiments, the layer on the walls of the honeycomb body may extend the entire axial length of the honeycomb body (i.e., extends along 100% of the axial length). However, in other embodiments, the material, which may be an inorganic layer, on the walls of the honeycomb body extends along at least 60% of the axial length, such as extends along at least 65% of the axial length, extends along at least 70% of the axial length, extends along at least 75% of the axial length, extends along at least 80% of the axial length, extends along at least 85% of the axial length, extends along at least 90% of the axial length, or extends along at least 95% of the axial length.

In embodiments, the material, which may be an inorganic layer, on the walls of the honeycomb body extends from the first end of the honeycomb body to the second end of the honeycomb body. In some embodiments, the material, which may be an inorganic layer, on the walls of the honeycomb body extends the entire distance from the first end of the honeycomb body to the second end of the honeycomb body (i.e., extends along 100% of a distance from the first end of the honeycomb body to the second end of the honeycomb body). However, in one or more embodiments, the layer or material, which may be an inorganic layer, on the walls of the honeycomb body extends along 60% of a distance between the first end of the honeycomb body and the second end of the honeycomb body, such as extends along 65% of a distance between the first end of the honeycomb body and the second end of the honeycomb body, extends along 70% of a distance between the first end of the honeycomb body and the second end of the honeycomb body, extends along 75% of a distance between the first end of the honeycomb body and the second end of the honeycomb body, extends along 80% of a distance between the end surface of the honeycomb body and the second end of the honeycomb body, extends along 85% of a distance between the first end of the honeycomb body and the second end of the honeycomb body, extends along 90% of a distance between the first end of the honeycomb body and the second end of the honeycomb body, or extends along 95% of a distance between the first end of the honeycomb body and the second end of the honeycomb body.

The selection of a honeycomb body having a low pressure drop in combination with the low thickness and high porosity of the layer on the honeycomb body according to embodiments allows a honeycomb body of embodiments to have a low pressure drop when compared to conventional honeycomb bodies. In embodiments, a loading of the inorganic deposits is between 0.1 to 30 g/L on the honeycomb body, such as between 0.1 to 20 g/L on the honeycomb body, or between 0.1 to 10 g/L on the honeycomb body. In other embodiments, the layer is between 0.1 to 20 g/L on the honeycomb body, such as between 0.1 to 10 g/L on the honeycomb body, and such as between 0.5 and 5 g/L. In specific embodiments, the loading of the inorganic material is in a range of from 0.1 to 5 g/L, 0.2 to 4.5 g/L, 0.3 to 4 g/L, 0.4 to 3.5 g/L, 0.5 to 3 g/L, 0.6 to 2.5 g/L, 0.7 to 2 g/L, 1 to 2 g/L on the honeycomb body. Loading of the inorganic material is weight of added material in grams divided by the geometric part volume in liters. The geometric part volume is based on outer dimensions of the honeycomb filter body (or plugged honeycomb body). In some embodiments, the pressure drop (i.e., a clean pressure drop without soot or ash) across the honeycomb body compared to a honeycomb without a thin porous inorganic material, which may be an inorganic layer, is less than or equal to 20%, such as less than or equal to 9%, or less than or equal to 8%. In other embodiments, the pressure drop across the honeycomb body is less than or equal to 7%, such as less than or equal to 6%. In still other embodiments, the pressure drop across the honeycomb body is less than or equal to 5%, such as less than or equal to 4%, or less than or equal to 3%.

As stated above, and without being bound to any particular theory, small pore sizes in the layer on the walls of the honeycomb body allow the honeycomb body to have good filtration efficiency even before ash or soot build-up occurs in the honeycomb body. The filtration efficiency of honeycomb bodies is measured herein using the protocol outlined in Tandon et al., 65 CHEMICAL ENGINEERING SCIENCE 4751-60 (2010). As used herein, the initial filtration efficiency of a honeycomb body refers to a new or regenerated honeycomb body that does not comprise any measurable soot loading. In embodiments, the initial filtration efficiency (i.e., clean filtration efficiency) of the honeycomb body is greater than or equal to 70%, such as greater than or equal to 80%, or greater than or equal to 85%. In yet other embodiments, the initial filtration efficiency of the honeycomb body is greater than 90%, such as greater than or equal to 93%, or greater than or equal to 95%, or greater than or equal to 98%.

The material, which may be an inorganic layer, on the walls of the honeycomb body according to embodiments is thin and has a porosity, and in some embodiments the layer on walls of the honeycomb body also has good chemical durability and physical stability. The chemical durability and physical stability of the material, which may be an inorganic layer, on the honeycomb body can be determined, in embodiments, by subjecting the honeycomb body to test cycles comprising burn out cycles and an aging test and measuring the initial filtration efficiency before and after the test cycles. For instance, one exemplary method for measuring the chemical durability and the physical stability of the honeycomb body comprises measuring the initial filtration efficiency of a honeycomb body; loading soot onto the honeycomb body under simulated operating conditions; burning out the built up soot at about 650° C.; subjecting the honeycomb body to an aging test at 1050° C. and 10% humidity for 12 hours; and measuring the filtration efficiency of the honeycomb body. Multiple soot build up and burnout cycles may be conducted. A small change in filtration efficiency (ΔFE) from before the test cycles to after the test cycles indicates better chemical durability and physical stability of the material, which may be an inorganic layer, on the honeycomb body. In some embodiments, the ΔFE is less than or equal to 5%, such as less than or equal to 4%, or less than or equal to 3%. In other embodiments, the ΔFE is less than or equal to 2%, or less than or equal to 1%.

In some embodiments, the material, which may be an inorganic layer, on the walls of the honeycomb body may be comprised of one or a mixture of ceramic components, such as, for example, ceramic components selected from the group consisting of SiO₂, Al₂O₃, MgO, ZrO₂, CaO, TiO₂, CeO₂, Na₂O, Pt, Pd, Ag, Cu, Fe, Ni, and mixtures thereof. Thus, the material, which may be an inorganic layer, on the walls of the honeycomb body may comprise an oxide ceramic. As discussed in more detail below, the method for forming the material, which may be an inorganic layer, on the honeycomb body according to embodiments can allow for customization of the layer composition for a given application. This may be beneficial because the ceramic components may be combined to match, for example, the physical properties—such as, for example coefficient of thermal expansion (CTE) and Young's modulus, etc.—of the honeycomb body, which can improve the physical stability of the honeycomb body. In some embodiments, the material, which may be an inorganic layer, on the walls of the honeycomb body may comprise cordierite, aluminum titanate, enstatite, mullite, forsterite, corundum (SiC), spinel, sapphirine, and periclase.

In some embodiments, the composition of the material, which may be an inorganic layer, on the walls of the honeycomb body is the same as the composition of the honeycomb body. However, in other embodiments, the composition of the layer is different from the composition of the honeycomb body.

The properties of the material, which may be an inorganic layer, and, in turn, the honeycomb body overall are attributable to the ability of applying a thin, porous material, which may be an inorganic layer, having small median pore sizes to a honeycomb body.

In some embodiments, the method of forming a honeycomb body comprises forming or obtaining an aerosol that comprises a ceramic precursor material and a solvent. The ceramic precursor material of the layer precursor comprises conventional raw ceramic materials that serve as a source of, for example, SiO₂, Al₂O₃, TiO₂, MgO, ZrO₂, CaO, CeO₂, Na₂O, Pt, Pd, Ag, Cu, Fe, Ni, and the like.

In one or more embodiments, the aerosol, which is preferably well-dispersed in a fluid, is directed to a honeycomb body, and the aerosol is deposited on the honeycomb body. In some embodiments, the honeycomb body may have one or more of the channels plugged on one end, such as, for example, the proximal end or first end 105 of the honeycomb body during the deposition of the aerosol to the honeycomb body. The plugged channels may, in some embodiments, be removed after deposition of the aerosol. But, in other embodiments, the channels may remain plugged even after deposition of the aerosol. The pattern of plugging channels of the honeycomb body is not limited. In other embodiments, only a portion of the channels of the honeycomb body may be plugged at one end. In such embodiments, the pattern of plugged and unplugged channels at one end of the honeycomb body is not limited and may be, for example, a checkerboard pattern where alternating channels of one end of the honeycomb body are plugged. By plugging all or a portion of the channels at one end of the honeycomb body during deposition of the aerosol, the aerosol may be distributed within the channels 110 of the honeycomb body 100.

Embodiments of honeycomb bodies and methods for forming the same as disclosed and described herein are now provided.

According to one or more embodiments, binders with high temperature (e.g., greater than 400° C.) resistance are included in the inorganic deposits, which may be an inorganic layer, to enhance integrity of the material at high temperatures encountered in automobile exhaust gas emissions treatment systems. In specific embodiments, the inorganic deposits comprise a binder in an amount of about 5 wt %. In one or more embodiments, the binder comprises an alkoxy-siloxane resin. In one or more embodiments, the binder is an inorganic binder. According to one or more embodiments, other potential inorganic and organic binders such as silicate (e.g. Na₂SiO₃), phosphate (e.g. AlPO₄, AlH₂(PO₄)₃), hydraulic cement (e.g. calcium aluminate), sol (e.g. mSiO₂·nH₂O, Al(OH)ₓ·(H₂O)₆₋ₓ) and metal alkoxides, could also be utilized in the inorganic deposits to increase mechanical strength by an appropriate curing process.

### EMBODIMENTS

Various embodiments are listed below. It will be understood that the embodiments listed below may be combined with all aspects and other embodiments in accordance with the scope of the invention.

Embodiment (a). A filtration article comprising: a plugged honeycomb filter body comprising: intersecting porous walls extending an axial length in an axial direction from a proximal end to a distal end of the honeycomb filter body and defining a plurality of axial channels comprised of inlet channels, which are plugged at the distal end of the plugged honeycomb filter body, and outlet channels, which are plugged at the proximal end of the plugged honeycomb filter body, the porous walls comprising: porous ceramic base portions with a plurality of pores and an average thickness and having inlet sides and outlet sides; inlet surfaces defining the inlet channels; outlet surfaces defining the outlet channels; and treated sides comprising hydrophobic material deposits disposed at one of the inlet sides or the outlet sides of the porous ceramic base portions.

Embodiment (b). The filtration article of embodiment (a), wherein the treated sides are comprised of exposed hydrophobic material deposits and any exposed areas of the porous ceramic base portions on the treated sides.

Embodiment (c). The filtration article of any of embodiments (a) to (b), wherein the hydrophobic material deposits are present as a hydrophobic coating.

Embodiment (d). The filtration article of any of embodiments (a) to (c), wherein the hydrophobic coating is present over at least part of the axial length.

Embodiment (e). The filtration article of embodiment (d), wherein the hydrophobic coating is present over an entire axial length.

Embodiment (f). The filtration article of any of embodiments (a) to (e), wherein the hydrophobic material deposits comprise one or more hydrophobic components.

Embodiment (g). The filtration article of any of embodiments (a) to (f), wherein the hydrophobic material deposits comprise an organic material, or a mixture of organic and inorganic materials.

Embodiment (h). The filtration article of embodiment (g), wherein the organic material is a wax-based compounds.

Embodiment (i). The filtration article of any of embodiments (a) to (h), wherein the hydrophobic material deposits comprise: a material selected from the group consisting of: soot, starch, and polymer powders.

Embodiment (j). The filtration article of any of embodiments (a) to (i), wherein the hydrophobic material deposits comprise one or more hydrophobic inorganic components.

Embodiment (k). The filtration article of any of embodiments (a) to (j), wherein the hydrophobic material deposits comprise hydrophobic silica.

Embodiment (l). The filtration article of any of embodiments (a) to (k), wherein the hydrophobic material deposits comprise one or more hydrophobic components and one or more non-hydrophobic components.

Embodiment (m). The filtration article of any of embodiments (a) to (k), wherein the hydrophobic material deposits comprise one or more hydrophobic components and no non-hydrophobic components.

Embodiment (n). The filtration article of any of embodiments (a) to (m), wherein the hydrophobic material deposits comprise: a mixture of organic and inorganic materials.

Embodiment (o). The filtration article of embodiment (n), wherein the mixture of organic and inorganic materials comprises hydrophobic silica.

Embodiment (p). The filtration article of any of embodiments (a) to (o), wherein non-treated sides comprise a catalytic material disposed at sides of the porous ceramic base portions which are opposite the treated sides.

Embodiment (q). The filtration article of embodiment (p), wherein the catalytic material comprises a three-way conversion (TWC) catalytic material.

Embodiment (r). The filtration article of any of embodiments (a) to (q), wherein the porous walls comprise a porosity of greater than or equal to 40% to less than or equal to 70%.

Embodiment (s). The filtration article of any of embodiments (a) to (r), wherein a loading of the hydrophobic material deposits is in a range of greater than or equal to 0.05 to less than or equal to 20 grams of the hydrophobic material deposits per liter of the plugged honeycomb filter body.

Embodiment (t). The filtration article of any of embodiments (a) to (s), wherein the hydrophobic material deposits comprise one or more organic materials having a vaporization temperature of greater than or equal to 400° C.

Embodiment (u). The filtration article of embodiment (t), wherein the vaporization temperature is greater than or equal to 500° C. to less than or equal to 600° C.

Embodiment (v). The filtration article of any of embodiments (a) to (u) further comprising inorganic deposits disposed at the inlet sides.

Embodiment (w). The filtration article of embodiment (v), wherein a loading of the inorganic deposits disposed within the plugged honeycomb filter body is less than or equal to 20 grams of the inorganic deposits per liter of the plugged honeycomb filter body.

Embodiment (x). The filtration article of any of embodiments (v) to (w), wherein the inorganic deposits are comprised of refractory inorganic nanoparticles bound by a binder comprising one or more inorganic components.

Embodiment (y). The filtration article of any of embodiments (a) to (x), wherein the inorganic deposits are comprised of refractory metal oxide nanoparticles.

Embodiment (z). The filtration article of embodiment (y), wherein the refractory metal oxide nanoparticles comprise alumina.

Embodiment (aa). A method for making a filtration article, the method comprising: applying a hydrophobic material to a plugged honeycomb filter body, the honeycomb filter body comprising intersecting porous walls extending an axial length in an axial direction from a proximal end to a distal end of the honeycomb filter body and defining a plurality of axial channels comprised of inlet channels, which are plugged at the distal end of the plugged honeycomb filter body, and outlet channels, which are plugged at the proximal end of the honeycomb filter body, the porous walls comprising: porous ceramic base portions with a plurality of pores and an average thickness and having inlet sides and outlet sides, inlet surfaces defining the inlet channels; and outlet surfaces defining the outlet channels; wherein treated sides of the porous ceramic base portions comprise the hydrophobic material disposed at one of the inlet sides or the outlet sides of the porous ceramic base portions; and thereafter applying catalytic material to non-treated sides of the porous ceramic base portions which are opposite the treated sides; and thereafter removing at least a portion of the hydrophobic material from the honeycomb filter body.

Embodiment (bb). The method of embodiment (aa), wherein the honeycomb filter body has bare surfaces and pores prior to the surface treatment.

Embodiment (cc). The method of any of embodiments (aa) to (bb), wherein at least a portion of the hydrophobic material is removed from the honeycomb filter body by heating the honeycomb filter body.

Embodiment (dd). The method of embodiment (cc), wherein the heating of the honeycomb filter body causes residual material to remain in the honeycomb filter body.

Embodiment (ee). The method of embodiment (dd), wherein the residual material comprises char and/or soot resulting from heating of the hydrophobic material.

Embodiment (ff). The method of embodiment (dd), wherein the residual material comprises inorganic particles resulting from heating of the hydrophobic material.

Embodiment (gg). The method of any of embodiments (aa) to (ff) further comprising calcining the catalytic material.

Embodiment (hh). The method of embodiment (gg), wherein at least a portion of the hydrophobic material is removed from the honeycomb filter body during the calcining.

Embodiment (ii). The method of embodiment (hh), wherein all of the hydrophobic material is removed from the honeycomb filter body during the calcining.

Embodiment (jj). The method of any of embodiments (aa) to (ii), wherein the inlet surfaces of the porous ceramic base portions are free of the catalytic material.

Embodiment (kk). The method of any of embodiments (aa) to (jj) further comprising removing all of the hydrophobic material from the honeycomb filter body.

Embodiment (ll). The method of any of embodiments (aa) to (kk) further comprising, after the applying of the hydrophobic material, applying an inorganic material to the treated sides.

Embodiment (mm). The method of any of embodiments (aa) to (kk) further comprising, after the applying of the hydrophobic material, applying an inorganic material to the non-treated sides.

Embodiment (nn). The method of any of embodiments (aa) to (kk) further comprising, after the applying of the hydrophobic material and before applying the catalytic material, applying an inorganic material to the treated sides.

Embodiment (oo). The method of any of embodiments (aa) to (kk) further comprising after the hydrophobic material and the catalytic material are applied, and before the hydrophobic material is removed, applying an inorganic material to the treated sides.

Embodiment (pp). The method of any of embodiments (aa) to (kk) further comprising after removing the hydrophobic material from the honeycomb filter body, applying an inorganic material at the treated sides where the hydrophobic material had been applied.

Embodiment (qq). The method of any of embodiments (aa) to (pp), wherein applying the hydrophobic material further comprises: exposing only one of an inlet side or an outlet side of a plugged honeycomb filter body to an organic material or a mixture of organic and inorganic materials.

Embodiment (rr). The method of embodiment (qq), wherein applying the hydrophobic material further comprises: infiltrating a mixture of particles of the organic material or the mixture of organic and inorganic materials and a liquid vehicle under vacuum to apply hydrophobic material deposits at only one of the inlet side or the outlet side.

Embodiment (ss). The method of any of embodiments (aa) to (rr), further comprising applying an inorganic material, including: atomizing particles of the inorganic material into liquid-particulate droplets comprised of a liquid vehicle and the particles; and evaporating substantially all of the liquid vehicle from the liquid-particulate droplets to form agglomerates and/or aggregates comprised of the particles.

Embodiment (tt). The method of any of embodiments (aa) to (ss), wherein the applying of the catalytic material comprises: preparing a slurry of a platinum group metal (PGM), alumina, and an oxygen storage component; and applying the slurry in the plugged honeycomb filter body.

Embodiment (uu). The method of any of embodiments (aa) to (tt) comprising depositing the hydrophobic material within the plugged honeycomb filter body at a loading in a range of greater than or equal to 0.5 to less than or equal to 20 grams of the hydrophobic material per liter of the plugged honeycomb filter body.

Embodiment (vv). The method of any of embodiments (aa) to (uu) comprising burning off at least a portion of the hydrophobic material at a temperature of greater than or equal to 400° C.

Embodiment (ww). The method of embodiment (vv), wherein the temperature is in a range of greater than or equal to 500° C. to less than or equal to 600° C.

Embodiment (xx). The method of any of embodiments (aa) to (ww), wherein the hydrophobic material comprises one or more hydrophobic components.

Embodiment (yy). The method of any of embodiments (aa) to (xx), wherein the hydrophobic material comprises an organic material, or a mixture of organic and inorganic materials.

Embodiment (zz). The method of embodiment (yy), wherein the organic material is a wax-based compound.

Embodiment (aaa). The method of any of embodiments (aa) to (yy), wherein the hydrophobic material comprises: a material selected from the group consisting of: soot, starch, and polymer powders.

Embodiment (bbb). The method of any of embodiments (aa) to (aaa), wherein the hydrophobic material comprises one or more hydrophobic inorganic components.

Embodiment (ccc). The method of any of embodiments (aa) to (yy), wherein the hydrophobic material comprises hydrophobic silica.

Embodiment (ddd). The method of any of embodiments (aa) to (ccc), wherein the hydrophobic material comprises one or more hydrophobic components and one or more non-hydrophobic components.

Embodiment (eee). The method of any of embodiments (aa) to (ccc), wherein the hydrophobic material comprises one or more hydrophobic components and no non-hydrophobic components.

Embodiment (fff). The method of any of embodiments (aa) to (eee), wherein the hydrophobic material comprises: a mixture of organic and inorganic materials.

Embodiment (ggg). The method of embodiment (fff), wherein the mixture of organic and inorganic materials comprises hydrophobic silica.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A method for making a filtration article, the method comprising:
applying a hydrophobic material to a plugged honeycomb filter body, the honeycomb filter body comprising intersecting porous walls extending an axial length in an axial direction from a proximal end to a distal end of the honeycomb filter body and defining a plurality of axial channels comprised of inlet channels, which are plugged at the distal end of the plugged honeycomb filter body, and outlet channels, which are plugged at the proximal end of the honeycomb filter body, the porous walls comprising: porous ceramic base portions with a plurality of pores and an average thickness and having inlet sides and outlet sides, inlet surfaces defining the inlet channels; and outlet surfaces defining the outlet channels;
wherein treated sides of the porous ceramic base portions comprise the hydrophobic material disposed at one of the inlet sides or the outlet sides of the porous ceramic base portions; and
thereafter applying catalytic material to non-treated sides of the porous ceramic base portions which are opposite the treated sides; and
thereafter removing at least a portion of the hydrophobic material from the honeycomb filter body.

2. (canceled)

3. The method of claim 1, wherein at least a portion of the hydrophobic material is removed from the honeycomb filter body by heating the honeycomb filter body.

4. (canceled)

5. (canceled)

6. (canceled)

7. The method of claim 1 further comprising calcining the catalytic material.

8. (canceled)

9. (canceled)

10. The method of claim 1, wherein the inlet surfaces of the porous ceramic base portions are free of the catalytic material.

11. (canceled)

12. (canceled)

13. (canceled)

14. (canceled)

15. (canceled)

16. (canceled)

17. The method of claim 1, wherein applying the hydrophobic material further comprises:
exposing only one of an inlet side or an outlet side of a plugged honeycomb filter body to an organic material or a mixture of organic and inorganic materials.

18. The method of claim 1, wherein applying the hydrophobic material further comprises:
infiltrating a mixture of particles of the organic material or the mixture of organic and inorganic materials and a liquid vehicle under vacuum to apply hydrophobic material deposits at only one of the inlet side or the outlet side.

19. The method of claim 1 further comprising applying an inorganic material, including:
atomizing particles of the inorganic material into liquid-particulate droplets comprised of a liquid vehicle and the particles; and
evaporating substantially all of the liquid vehicle from the liquid-particulate droplets to form agglomerates and/or aggregates comprised of the particles.

20. The method of claim 1, wherein the applying of the catalytic material comprises:
preparing a slurry of a platinum group metal (PGM), alumina, and an oxygen storage component; and
applying the slurry in the plugged honeycomb filter body.

21. The method of claim 1 comprising depositing the hydrophobic material within the plugged honeycomb filter body at a loading in a range of greater than or equal to 0.5 to less than or equal to 20 grams of the hydrophobic material per liter of the plugged honeycomb filter body.

22. The method of claim 1 comprising burning off at least a portion of the hydrophobic material at a temperature of greater than or equal to 400° C.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. A filtration article comprising:
a plugged honeycomb filter body comprising:
intersecting porous walls extending an axial length in an axial direction from a proximal end to a distal end of the honeycomb filter body and defining a plurality of axial channels comprised of inlet channels, which are plugged at the distal end of the plugged honeycomb filter body, and outlet channels, which are plugged at the proximal end of the plugged honeycomb filter body, the porous walls comprising:
porous ceramic base portions with a plurality of pores and an average thickness and having inlet sides and outlet sides;
inlet surfaces defining the inlet channels;
outlet surfaces defining the outlet channels; and
treated sides comprising hydrophobic material deposits disposed at one of the inlet sides or the outlet sides of the porous ceramic base portions.

35. The filtration article of claim 34, wherein the treated sides are comprised of exposed hydrophobic material deposits and any exposed areas of the porous ceramic base portions on the treated sides.

36. The filtration article of claim 34, wherein the hydrophobic material deposits are present as a hydrophobic coating.

37. The filtration article of claim 36, wherein the hydrophobic coating is present over at least part of the axial length.

38. (canceled)

39. (canceled)

40. The filtration article of claim 34, wherein the hydrophobic material deposits comprise an organic material, or a mixture of organic and inorganic materials.

41. The filtration article of claim 40, wherein the organic material is a wax-based compounds.

42. The filtration article of claim 34, wherein the hydrophobic material deposits comprise: a material selected from the group consisting of: soot, starch, and polymer powders.

43. (canceled)

44. The filtration article of claim 34, wherein the hydrophobic material deposits comprise hydrophobic silica.

45. (canceled)

46. (canceled)

47. (canceled)

48. (canceled)

49. The filtration article of claim 34, wherein non-treated sides comprise a catalytic material disposed at sides of the porous ceramic base portions which are opposite the treated sides.

50. The filtration article of claim 49 wherein the catalytic material comprises a three-way conversion (TWC) catalytic material.

51. The filtration article of claim 34, wherein the porous walls comprise a porosity of greater than or equal to 40% to less than or equal to 70%.

52. The filtration article of claim 34, wherein a loading of the hydrophobic material deposits is in a range of greater than or equal to 0.05 to less than or equal to 20 grams of the hydrophobic material deposits per liter of the plugged honeycomb filter body.

53. The filtration article of claim 34, wherein the hydrophobic material deposits comprise one or more organic materials having a vaporization temperature of greater than or equal to 400° C.

54. (canceled)

55. The filtration article of claim 34 further comprising inorganic deposits disposed at the inlet sides.

56. (canceled)

57. The filtration article of claim 55, wherein the inorganic deposits are comprised of refractory inorganic nanoparticles bound by a binder comprising one or more inorganic components.

58. (canceled)

59. The filtration article of claim 57, wherein the refractory metal oxide nanoparticles comprise alumina.
